(19) United States
(12) Patent Application Publication
(10) Pub. No.: US 2020/0042989 A1
(43) Pub. Date: Feb. 6, 2020

(54) ASSET-BACKED TOKENS

(71) Applicants: Ramesh Ramadoss, San Jose, CA (US); Bao Tran, Saratoga, CA (US)

(72) Inventors: Ramesh Ramadoss, San Jose, CA (US); Bao Tran, Saratoga, CA (US)

(21) Appl. No.: 16/523,051

(22) Filed: Jul. 26, 2019

Related U.S. Application Data
(60) Provisional application No. 62/712,505, filed on Jul. 31, 2018.

(51) Int. Cl. G06Q 20/36; H04L 9/06; G06Q 20/06; G06Q 50/16

(52) U.S. Cl. CPC G06Q 20/3672; H04L 9/0637; G06Q 50/167; G06Q 50/163; G06Q 20/0658

(57) ABSTRACT

Systems and methods are disclosed to tokenize an asset by: documenting a value for the asset by a promoter of the asset, generating a plurality of cryptocurrency coins/tokens corresponding to the value of the asset; embedding in the cryptocurrency coins/tokens a smart contract one or more investment terms including asset description, payment and timing; obtaining subscriptions and payments for the asset from a crowd; holding subscription payments from the crowd in escrow until a predefined condition is met; and releasing the coins/tokens to the promoter and recording ownership interest from the crowd.

This application claims priority to Provisional Application 62/712,505 filed 31 Jul. 2018, the content of which is incorporated by reference.

### FIELD OF THE INVENTION

The present invention relates to systems and methods for tokenizing property and assets.

### BACKGROUND OF THE INVENTION

Real estate plays an integral role in the U.S. economy. Residential real estate provides housing and often is the greatest source of wealth and savings for many families. Commercial real estate, which includes apartment buildings, create jobs and spaces for retail, offices and manufacturing. To make large real estate purchases without paying the entire value of the purchase up front, mortgages are used by individuals and businesses. Over a period of many years, the borrower repays the loan, plus interest, until he/she eventually owns the property free and clear. If the borrower stops paying the mortgage, the lender can foreclose where the bank may evict the home's tenants and sell the house, using the income from the sale to clear the mortgage debt. Mortgages are also known as “liens against property” or “claims on property.” While first liens are common, it is possible to have second or even third liens. If taxes are not paid, they can show up as tax liens and have super-priority.

Other properties such as cars also play a significant role in the economy. A new car may cost the equivalent of a year's wages or more. Financing options and leases make cars more affordable to some buyers in the short term but make the process more complex. Along with rent or a mortgage payment, the monthly car payment figures prominently in the day-to-day finances of many drivers. Similar to home loans, lenders can lend money to buy car and their interests are often protected by car liens.

Lenders lend money secured by real or personal property in exchange for an income stream—i.e. the payment of interest. Lenders are not interested in the secured asset per se, but they are extremely interested in maintaining their income stream. When a borrower defaults, this income stream is interrupted, which causes the lender to lose income as its investment is now tied up in an illiquid non-performing loan.

When the loan is secured by real property, the lender's loss is more than the interest carried. Many homeowners in default also do not pay their property taxes, do not pay for homeowner's insurance, and many times fail to repair the home. Failing to pay any of these expenses can impair the lender's interest in the asset, as the county may foreclose for non-payment of taxes, a fire may destroy the uninsured property, or code violations may cause liability or condemnation issues. Hence, a lender will also have to pick up these expenses in addition to the interest carry. The combination of these factors is known in the mortgage industry as “carry cost”, and is generally estimated to run about 1.5% per month of the unpaid loan balance. Hence, the lender is extremely interested in either returning the income stream to performing status quickly, or liquidating the asset as quickly as possible to limit exposure to carry cost. The process of liquidating the asset is done as a “security interest enforcement action” (or “SIEA”), or a legal process used to enforce a security interest. SIEA's include: (1) actions to enforce liens secured by real property (i.e. foreclosures), (2) actions to take possession of real property (i.e. evictions), and (3) actions to take possession of personal property (i.e. “replevin actions”). These actions are generally brought by lenders having a security interest in property.

### SUMMARY OF THE INVENTION

The present invention is directed to tokenization of assets.

In a first aspect, a method to tokenize an asset includes: documenting a value for the asset by a promoter of the asset, generating a plurality of cryptocurrency coins/tokens corresponding to the value of the asset; embedding in the cryptocurrency coins/tokens a smart contract one or more investment terms including asset description, payment and timing; obtaining subscriptions and payments for the asset from a crowd; holding subscription payments from the crowd in escrow until a predefined condition is met; and releasing the coins/tokens to the promoter and recording ownership interest from the crowd. The asset can be real estate, debt notes, cars, start-up ownership, among others.

In another aspect, a method for creating and selling a smart contract in the form of a cryptocurrency that provides equity participation to an investor in a property such as a homeowner's residential real estate property. A contract is executed between the homeowner and an originator in which the mortgage originator purchases an equity portion of the residential real estate property from the homeowner. In connection with the purchasing, the homeowner grants a lien on the homeowner's residential real estate property to the originator in order to secure a future payment obligation of the homeowner. The future payment obligation is imposed on the homeowner to make a future equity participation payment to the contract holder at a future time. The future equity participation payment has an amount comprising an initial equity portion payment plus a predetermined percentage of an increase in value of the residential real estate property between a time of execution of the contract and a time of sale of the residential real estate property. A security is created by pooling the contract with other contracts sold to a plurality of other homeowners each of whom owns at least one of a plurality of residential real estate properties, and selling the security to an institutional investor in a secondary market. The security provides that, upon a sale of each given residential real estate property, the institutional investor has a right to receive a payment amount comprising the initial equity portion payment for the residential real estate property plus a predetermined percentage of an increase in value of the residential real estate property between the time of execution of the contract for the residential real estate property and the time of the sale of the residential real estate property.

In another aspect, systems and methods are disclosed for applying blockchain-enabled “Asset-backed Tokenization” to real estate mortgage loans or notes or non-performing notes. Investors and note sellers are able to participate and benefit from the system through two different tokens: utility tokens which enable global users to access platform services such as listing, purchase and sale of mortgage notes, and asset-backed security tokens which enable global REIT operations.

Advantages of the system may include one or more of the following. The system improves on the storage and processing of transactions that utilize blockchain currencies. The system improves on the speed and transparency over fiat currency in being able to safely store and protect consumer and merchant information and credentials and to transmit sensitive data between computing systems. In addition, the system can perform complex calculations, risk assessments, and fraud algorithm applications extremely fast, as to ensure quick processing of fiat currency transactions. The system can work with traditional payment networks and payment systems technologies in combination with blockchain currencies to provide consumers and merchants the benefits of the decentralized blockchain while still maintaining security of account information and provide a strong defense against fraud and theft.

Other advantages of the system may include one or more of the following. The system allows property owners to share equity interests in their properties such as commercial or residential real estate with investors, in a way that permits both the property owners and the investors to share in appreciation of property. Property owners and investors would benefit greatly from a financial instrument that provided for such shared property ownership. This is achieved while minimizing risk of centralization using secure digital tokens, contracts, insurance, auditing and third-party guarantees. The system leverages blockchain properties: cryptographically secured transactions, distributed ledger technology, smart contracts. The use of blockchain eliminates the need of (i) intermediaries to execute transactions (self-executed by smart contracts), (ii) the need of intermediaries to keep the record of transactions and facilitate them (transactions are recorded in the ledger), (iii) solves double spending problem (eliminating potential fraud), and (iv) provides a database showing the complete history of ownership. Transactions are stored at a distributed ledger eliminating the possibility of single point failures and unresponsive servers, and the data stored on the blockchain is immutable, complete, transparent, and allows to integrate principles of management into the assets themselves. Asset tokenization through the present system can effectively reduce information asymmetry, decrease the friction to trade and democratize trading system in general, ridding the market from vast bureaucracy and red tape (in traditional markets there is a need to go through know-your-customer (KYC) and compliance checks at each and every opening of an account, signing of contracts, paying of commissions, etc.). Other advantages may include:
Asset tokenization enhances liquidity of assets that otherwise have a very low liquidity. Real estate occupies the largest share of the global asset market and has low liquidity.
It allows asset owners to capture liquidity premiums from assets that otherwise, due to low liquidity would not be actively traded. (liquidity is not binary, it is a continuum, and low liquidity or illiquidity means that the assets are expensive to trade (Aswath Damodaran)).
Tokenization enables new economic models around asset ownership, such as fractional ownership (investors can own a certain percentage of a certain asset), thus users can purchase one cheap piece rather than an expensive whole.
Tokenization through fractional ownership allows diversification of risk arising out of asset ownership (one wholly owned asset can be damaged and lose its value, while fractional ownership allows diversification of risk though owning a part of several assets).
Tokenization and ease of transactions eliminate temporal and territorial barriers for asset owners for attracting investments (tokenized securities can be sold globally without territorial restrictions).
Asset tokenization effectively reduced entry barriers for trading and investing, by lowering the minimum payment charged for participating in the trading.
It enables newer models of raising capital, by allowing projects that are under development to issue shares in form of tokens to finance project development.
Enables to utilize network effect for certain products to increase their popularity in the market, by providing direct financial incentive to fractional owners (an influencer that has a fractional ownership of a product, is incentivized to bring further public attention into the asset).
Tokenization reduces administrative expenses (excessive documentation), smart contracts execute agreements instantly (improving speed of settlements).
Tokenization offers further security advantages. Fears that paper bonds are duplicates are dispelled, because tokens are unique, unable to be imitated, copied or double spent.

### BRIEF DESCRIPTION OF THE DRAWINGS

FIGS. 1A-1C show an exemplary platform to tokenize assets for objects of value that needs financing or investment.

FIG. 1D shows an exemplary operation using the above platform.

FIG. 2A-2B show exemplary user interface to tokenize real estate debt.

FIG. 3A shows exemplary blockchain asset operations (BAOs) to tokenize intangibles such as notes/liens, among others.

FIG. 3B shows exemplary BAOs to tokenize property such as real estate property or cars, among others.

FIG. 3C shows exemplary BAOs to tokenize assets such as securities and stocks, for example crowd-funding operations, among others.

FIG. 4 shows an exemplary token investment system.

FIG. 5 is a block diagram illustrating a high-level system architecture for managing blockchain cryptocurrency for asset-backed transactions in accordance with exemplary embodiments.

FIG. 6 is a block diagram illustrating the processing server of FIG. 1 for authorizing blockchain transactions and linking blockchain transactions to privately verified identifies in accordance with exemplary embodiments.

FIG. 7 is an illustrative note transaction with tokens in accordance with exemplary embodiments.

FIG. 8 is a flow diagram illustrating a trading system for REIT tokens.

FIG. 9 is a flow chart illustrating an exemplary method for managing asset-backed debt using blockchain cryptocurrency in accordance with exemplary embodiments.

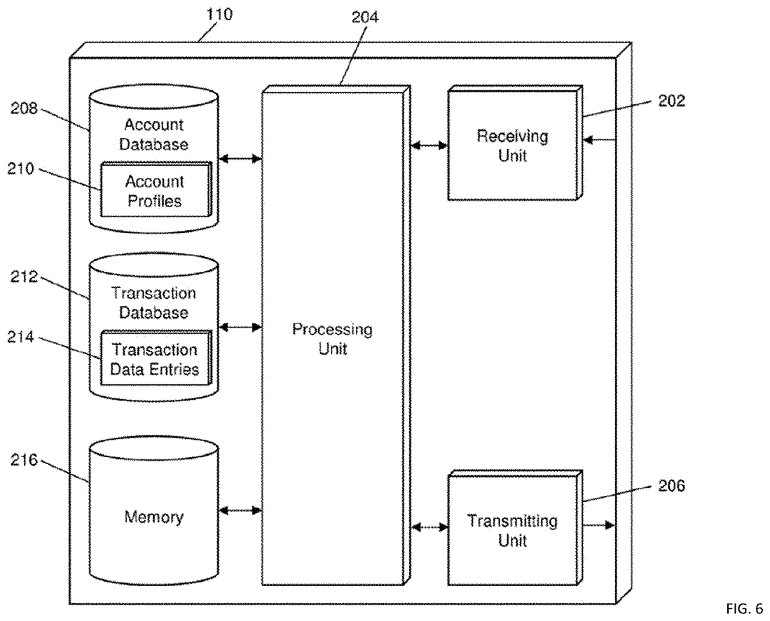

FIGS. 6-14 show exemplary flows in a system to deploy asset-backed tokens.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION OF THE PREFERRED EMBODIMENTS

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Non-Limiting Definitions

The terms “a”, “an” and “the” are intended to include the plural forms as well, unless the context clearly indicates otherwise.

As used herein, the term “bank-owned real property assets” means any developed or undeveloped residential or commercial property owned in whole or in part by a bank. For example, a bank-owned real property asset may be a foreclosed residential home wherein the bank has more than 50% ownership interest. In another example, the bank-owned real property asset may comprise a so called “Legacy (or Toxic) Asset”—i.e. an asset that has been owned by the bank for such a long time that it actually has lost its original value, is outdated, obsolete or has lost its productivity. Such bank-owned properties are termed “assets” herein (as opposed to “liabilities”) regardless of their relative value. Lastly, in a third example, a bank-owned property asset may be a mortgage note held by the bank against a subject property in whose mortgagor desires to refinance or at a below market interest rate.

The term “below market mortgage rate” is defined as a mortgage rate at or below the current Wall Street Journal Prime Rate Index (WSJ Current Prime Rate Index).

The term “blockchain” is a distributed database that keeps a continuously growing list of data records. Each data record is protected against tampering and revisions. Blockchains are used with public ledgers of transactions, where the record is enforced cryptographically.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

The term “computing node” is used to mean computational device with an internal address that can host a copy of a blockchain and the associated transactions.

The “face value” of the mortgage refers to the amount of the loan without taking interest or other fees into consideration. For example, although a $300,000 mortgage may require payment of tens of thousands of dollars in interest over the course of the loan, the face value of the mortgage remains $300,000.

The term “government security” means a negotiable U.S. Treasury Bond or any other negotiable specific world government instrument.

The term “non-governmental organization security” (NGO) means a negotiable or administratively issued financial instrument from a non-governmental organization. For example, the International Monetary Fund, World Bank or BRICS Development Bank.

The term “hash function” is a mathematical algorithm turns an arbitrarily large amount of data into a fixed-length size. The same hash will always result from the same data, but modifying the data by even one bit will completely change the hash. The values returned by the hash function are called a “hash”.

The term “public ledger” is a public accessible listing of transactions for the distributed database or blockchain.

The term “private ledger” is a privately accessible listing of transactions for the distributed database or blockchain.

The term “real estate” covers commercial buildings and residential dwellings, including but not limited to houses, townhouses, condominiums, owned apartments, and co-ops.

The term “Transaction Account” covers a financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

The term blockchain covers a public ledger of all transactions of a blockchain-based cryptocurrency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc.

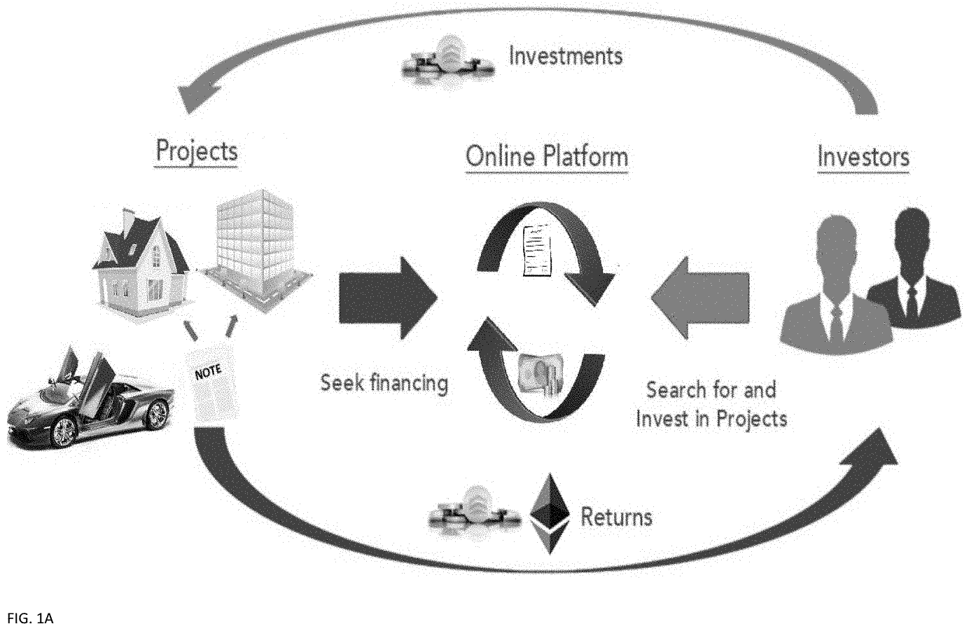

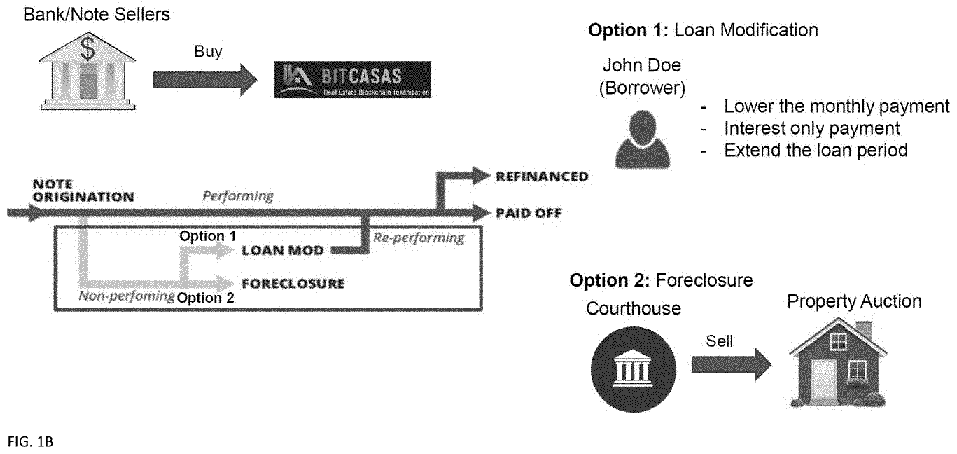

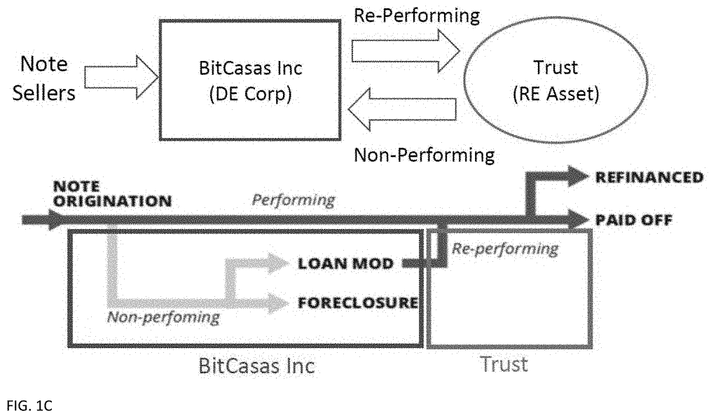

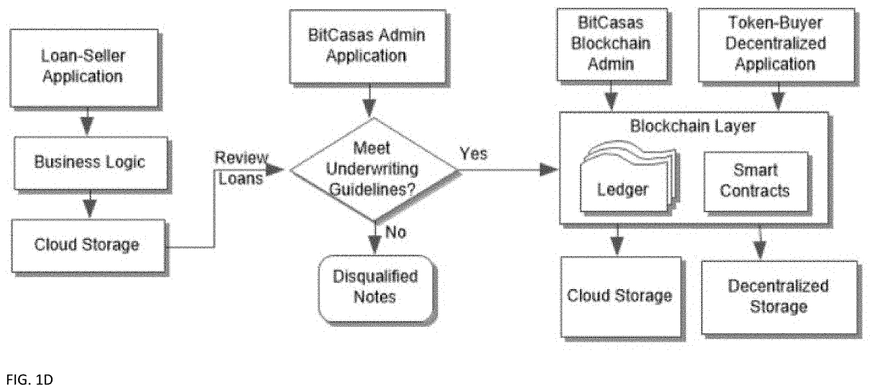

FIG. 1A shows an exemplary platform to tokenize assets such as buildings, homes, cars, or any objects of value that needs financing or investment. The system can be used to raise money for a start-up by selling utility coins/tokens or asset-backed security coins/tokens. The system can also handle intangibles such as mortgages, debt notes, patents, copyrights, trademarks, trade secrets, and other intellectual property. The system has a project owner or entrepreneur that makes a case for investments into a project, the case is documented and listed on an on-line platform. The platform in turn vets the proposal before listing the project. The vetting can be done by professionals at the platform, or community-based vetting can be done, where verification by community vetters are paid in coins/tokens issued by the platform. Every transaction made by the community also contributes a small amount to an insurance fund to protect investors in case of fraud. Based on the representations from the project entrepreneur and self-policing by the platform, investors can confidently search for prospects using the platform, and make investments in the projects using cryptocurrency coins/tokens that also have smart contract functions. The smart contracts would transfer money to the entrepreneurs upon matching the required conditions set by the entrepreneurs, and the platform would retain a lien or escrow on the property to ensure performance by the entrepreneur.

The transactions on the platform are recorded on a blockchain database or a data structure as a sequential transactional database that may be distributed and is communicatively connected to a network. For convenience, such a database is herein referred to as a blockchain through other suitable databases, data structures or mechanisms possessing the characteristics of a sequential transactional database can be treated similarly. A blockchain provides a distributed chain of block data structures accessed by a network of nodes known as a network of miners. Each block in the blockchain includes one or more transaction data structures. In some blockchains, such as the BitCoin blockchain, the blockchain includes a Merkle tree of hash or digest values for transactions included in the block to arrive at a hash value for the block, which is itself combined with a hash value for a preceding block to generate a chain of blocks (blockchain). A new block of transactions is added to the blockchain by miner software, hardware, firmware or combination components in the miner network. Miners are communicatively connected to sources of transactions and access or copy the blockchain. A miner undertakes validation of a substantive content of a transaction (such as criteria and/or executable code included therein) and adds a block of new transactions to the blockchain when a challenge is satisfied, typically such challenge involving a combination hash or digest for a prospective new block and a preceding block in the blockchain and some challenge criterion. Thus, miners in the miner network may each generate prospective new blocks for addition to the blockchain. Where a miner satisfies or solves the challenge and validates the transactions in a prospective new block such new block is added to the blockchain. Accordingly, the blockchain provides a distributed mechanism for reliably verifying a data entity such as an entity constituting or representing the potential to consume a resource.

To protect the investor, the smart contract includes a hypothecation clause. Hypothecation is an agreement whereby a person puts up collateral to secure the debt of another. This means that a person (not the debtor) agrees that a piece of real estate belonging to him/her will be collateral for a debt. If the debt is not paid, the creditor may have the property seized to satisfy the debt, although the person hypothecating the property is not personally liable if the collateral doesn't pay off the debt. Thus in hypothecation, the property is liable for the debt, not the person guaranteeing the debt.

Another embodiment uses tacit hypothecation clause. Tacit hypothecation refers to a type of lien or mortgage that is created by law. However, it is made without the parties express agreement. Should the party argue that the smart contract alone without signature is not an express agreement, tacit hypothecation is at once created and vested in the damaged party, subject to be defeated only by unreasonable laches in bringing the proceeding in rem, by which alone it can be enforced.

In one embodiment, security interests can be created by the platform. In one embodiment, the UCC tangible collateral category are embedded in the smart contracts to cover 1) inventory, 2) equipment, 3) consumer goods, and 4) farm products. The system includes attachment code with 1) a security smart contract, 2) debtor with rights in the collateral, and 3) investor or creditor who gives value. The blockchain title is used to avoid the situation where the debtor agent has given more than one security interest, the collateral has been transferred, or against a bankruptcy Trustee. Attachment establishes the creditor's rights against the debtor and is necessary for the secured party to repossess the collateral or related proceeds from the debtor. Security Agreement is an authenticated blockchain record authenticated by debtor, reasonably identify the location and use of the collateral good or data. The system includes smart contract code to assert a purchase money security interest (PMSI) by mere attachment for certain goods such as consumer goods. The blockchain is used for perfection to protect the creditor agent against third parties. Perfection can be accomplished through 1) possession 2) control 3) filing 4) mere attachment, or 5) title certificate. Filing of a financing statement is at the location of the debtor. Filing of the security interest on the blockchain gives constructive notice to all and is effective at the time of filing.

The system tokenizes ownership with the blockchain with a number of advantages, one of which is Affordability: Based on the tokenization model, high value properties can be put up for sale in the form of tokens. These tokens represent portions of the properties. The system enables Diversification: instead of putting a large amount of capital in a single investment, investors can divide capital and invest in smaller pieces of multiple investment projects. The system enables fast Market Liquidity: Each ownership token can be independently traded, which creates a lower point of entry for participants to own a piece of real estate, as compared to the traditional way. The system provides Versatility: assets ownership tokens can be transferred, inherited, or used as collateral. Each token is basically a store of value that is backed by real estate in the real world. Everyone can gain access to the global investment market, for example in exotic cars or real estate.

FIG. 1B shows an exemplary operation process using the system of FIG. 1A. In this system, banks, funds, or note sellers sell notes to a sponsor company such as BitCasas. The sponsor buys the notes in bulk and separates the notes into performing or non-performing notes. Performing notes can be placed into one trust that collects monthly payments and returns dividends using the blockchains to investors in the sponsor. Non-performing notes are in turn grouped into loan modification or work-out for debtors who are willing or into foreclosure group. The loan modifications are classified as reperforming if the debtors pay over a period of time such as 8-12 months and those loans are then treated the same as performing notes. The loan modification can include reducing monthly payment, making interest only payment, and extending the loan payment period. The foreclosure process involves the judicial system, and the property can be sold or auctioned off.

FIG. 1C shows one exemplary trust structure to use the processes of FIGS. 1A-1B. In this structure, an entity acts as a sponsor of a holding structure (such as a trust) that holds the performing and reperforming assets. The asset holding structure can be a Delaware statutory trust (DST) or a tenancy in common (TIC), for example. The sponsor issues a token for the operation of the sponsor, while the holding structure issues asset-backed tokens representing the real estate backed notes on the blockchain, and investors have liquidity and visibility of assets on the blockchain in this example.

FIG. 1D shows an exemplary platform architecture. In this system, a loan seller completes information on the loans or debt and such information is processed using business logic to automatically classify and reject applications whose loans that do not meet predetermined criteria. The applications that pass the criteria are stored in a cloud storage for additional reviews.

An administrator using a separate application reviews the loans for compliance with the underwriting guidelines. If the criteria are not met, the notes are disqualified, and otherwise the selected loans/notes are purchased for the trust, and then placed on the blockchain. A blockchain admin manages the blockchain data, and investors who buy the tokens issued by the trust (token buyers) have a decentralized application that communicates with the blockchain. In addition, the blockchain layer communicates with a cloud storage which stores the notes, the debt recordation, among others. Decentralized storage such as InterPlanetary File System (IPFS) can be used, among others.

The property or asset-backed note can be electronically connected to the blockchain with a smart phone, computer, tablet computer, or suitable mobile device. According to various embodiments of the present disclosure, the electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an MP3 player, a mobile medical device, a camera, a wearable device (e.g., a Head-Mounted Device (HMD), electronic clothes, electronic braces, an electronic necklace, an electronic accessory, an electronic tattoo, or a smart watch), and/or the like. According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box, a gaming console, an electronic dictionary, an electronic key, a camcorder, an electronic picture frame, and/or the like. According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like. According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality. In one embodiment, a smart device includes sensor(s) and wireless communication therein. The device can detect tension and communicate to a computer for storage and analysis. The smart device provides an automatic electronic process that eliminates the need for a manual inspection process, and uses electronic detection of stress, eliminating subjective human judgments and producing greater uniformity in maintenance, inspection, and emergency detection procedures. According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

The mobile device can store data from sensors or from transactions placed on the device using the blockchain. Any suitable cryptocurrency may be employed in the embodiments disclosed herein, such as bitcoin or Ethereum. The characteristics and implementation of a suitable cryptocurrency, such as bitcoin, are well known. In general, a cryptocurrency is a medium of exchange using cryptography to secure the transactions and to control the creation of additional units of the currency. The blockchain is maintained by servers on the Internet in order to verify, facilitate, and record every transaction. The distributed nature of the blockchain over multiple nodes in the network together with a suitable form of timestamping (e.g., proof-of-work) ensures the security and authenticity of the database. Each unit of cryptocurrency (e.g., each bitcoin or fraction of bitcoin) is assigned to a public cryptocurrency address that is recorded in the blockchain, wherein the unit of currency may be transferred out of the public address (e.g., to another public address) using a private cryptocurrency key held by the current “owner” of the unit. In addition, the current balance of any particular public cryptocurrency address may be checked by any entity by executing a query of the blockchain database. Another embodiment works with Ethereum which is a platform that allows people to easily write decentralized applications (dApp) using blockchain. A decentralized application is an application which serves some specific purpose to its users, but which has the important property that the application itself does not depend on any specific party existing. The Ethereum blockchain can be alternately described as a blockchain with a built-in programming language, or as a consensus-based globally executed virtual machine. The part of the protocol that actually handles internal state and computation is referred to as the Ethereum Virtual Machine (EVM). From a practical standpoint, the EVM can be thought of as a large decentralized computer containing millions of objects, called “accounts”, which have the ability to maintain an internal database, execute code and talk to each other.

In one embodiment, the blockchain uses a database called a Patricia tree (or “trie”) to store all accounts; this is essentially a specialized kind of Merkle tree that acts as a generic key/value store. Like a standard Merkle tree, a Patricia tree has a “root hash” that can be used to refer to the entire tree, and the contents of the tree cannot be modified without changing the root hash. For each account, the tree stores a 4-tuple containing [account nonce, ether balance, code hash, storage root], where account nonce is the number of transactions sent from the account (kept to prevent replay attacks), ether balance is the balance of the account, code hash the hash of the code if the account is a contract and otherwise, and storage root is the root of yet another Patricia tree which stores the storage data. Unlike Bitcoin, Ethereum blocks contain a copy of both the transaction list and the most recent state. Aside from that, two other values, the block number and the difficulty, are also stored in the block. The basic block validation algorithm in Ethereum is as follows:

Check if the previous block referenced exists and is valid.

Check that the timestamp of the block is greater than that of the referenced previous block and less than 15 minutes into the future

Check that the block number, difficulty, transaction root, uncle root and gas limit (various low-level Ethereum-specific concepts) are valid.

Check that the proof of work on the block is valid.

There are two types of accounts:

Externally owned account (EOAs): an account controlled by a private key, and if you own the private key associated with the EOA you have the ability to send ether and messages from it.

Contract: an account that has its own code and is controlled by code.

When a user sends a transaction, if the destination of the transaction is another EOA, then the transaction may transfer some ether but otherwise does nothing. However, if the destination is a contract, then the contract in turn activates, and automatically runs its code. The code has the ability to read/write to its own internal storage (a database mapping 32-byte keys to 32-byte values), read the storage of the received message, and send messages to other contracts, triggering their execution in turn. Once execution stops, and all sub-executions triggered by a message sent by a contract stop (this all happens in a deterministic and synchronous order, i.e. aa sub-call completes fully before the parent call goes any further), the execution environment halts once again, until woken by the next transaction.

The system also works with proof-of-stake which replaces miners with validators:
The validators will have to lock up some of their coins/tokens as stake.
After that, they will start validating the blocks. Meaning, when they discover a block which they think can be added to the chain, they will validate it by placing a bet on it.
If the block gets appended, then the validators will get a reward proportionate to their bets.

Malicious elements are punished as follows:
The validators stake a portion of their Ethers as stake.
After that, they will start validating the blocks. Meaning, when they discover a block which they think can be added to the chain, they will validate it by placing a bet on it.
If the block gets appended, then the validators will get a reward proportionate to their bets.
However, if a validator acts in a malicious manner and tries to do a “nothing at stake”, they will immediately be reprimanded, and all of their stake is going to get slashed.

In one embodiment, the service 20 can have one or more underwriters and relayers. In traditional debt markets, underwriters are entities that collect fees for administering the public issuance of debt and pricing borrower default risk into the asset. In the protocol, this definition is expanded and formalized. An underwriter is a trusted entity that collects market-determined fees for performing the following functions:
Originating a debt order from a borrower
Determining and negotiating the terms of the debt (i.e. term length, interest, amortization) with the potential debtor
Cryptographically committing to the likelihood they ascribe to that debt relationship ending in default (process described in detail under Specification)
Administering the debt order's funding by forwarding it to any number of relayers.
Servicing the debt—i.e. doing everything in the underwriter's reasonable power to ensure timely repayment according to the agreed upon terms.

In the case of defaults or delinquencies, collecting on collateral (if debt is secured) or the individual's assets via legal mechanisms and passing collected proceeds to investors.

Relayers aggregate signed debt order messages and, for an agreed upon fee, host the messages in a centralized order book and provide retail investors with the ability to invest in the requested debt orders by filling the signed debt orders. Relayers need not hold any agent's tokens—they simply provide a mechanism for creditors to browse through aggregated signed debt order messages, which creditors can use to trustlessly issue themselves debt tokens in exchange for the requested principal via client-side contract interactions (this mechanism is specified later in this paper).

One embodiment leverages several contracts deployed on the Ethereum network. The contracts have one or more of the following:

Debt Kernel

The debt kernel is a simple smart contract that governs all business logic associated with minting non-fungible debt tokens, maintaining mappings between debt tokens and their associated term contracts, routing repayments from debtors to creditors, and routing fees to underwriters and relayers. These mechanisms are easier to define within the context of the debt lifecycle and are extensively elaborated on in the below specification.

Terms Contract(s)

Terms contracts are Ethereum smart contracts that are the means by which debtors and creditors agree upon a common, deterministically defined set of repayment terms. By extension, terms contracts expose a standard interface of methods for both registering debtor repayments, and programmatically querying the repayment status of the debt asset during and after the loan's term. A single terms contract can be reused for any number of debt agreements that adhere to its repayment terms—for instance, a terms contract defining a simple compounded interest repayment scheme can be committed to by any number of debtors and creditors. The exact interface for this is defined within the specification below.

An alternative scheme for committing to loan terms would be to commit to a standardized schema of plaintext loan terms (Ricardian contracts) on chain and assess loan repayment off-chain in client applications. Preferably, the system commits to a terms contract on-chain removes any ambiguity from the evaluation of a loan's repayment status—the contract is a single, programmatic, and immutable source of truth that is queryable by both contracts and clients. Finally, having an on-chain provider of repayment status greatly simplifies the mechanisms by which on-chain collateralized debt agreements can be structured and collected on in cases of default.

Repayment Router

The repayment router contract is constructed to trustlessly route repayments from debtors to debt agreement beneficiaries (i.e. owners of the debt tokens). Additionally, the repayment router acts as a trusted oracle to the Terms Contract associated with any given debt agreement, reporting to it the exact details of each repayment as it occurs. This enables the terms contract to serve as a trustless interface for determining the default status of a debt.

The debtor's adherence to the chosen terms contract and the underwriter's prediction of default likelihood are committed to on-chain.

A non-fungible, non-divisible debt token is minted to the creditor and mapped to the above commitment.

The principal amount is transferred from the creditor to the debtor (minus fees) and any keepers' fees are similarly transferred from the creditor.

In one embodiment, the user's own cryptocurrency is used to augment the security information used to access an online account, such as augmenting a user name/password combination which may or may not include any suitable two-factor authentication. In another embodiment, a cryptocurrency may be used in place of conventional security information, such as replacing a username/password with a public cryptocurrency address. That is in one embodiment, the only security information transmitted by a user to a service provider in order to access an online account may be a public cryptocurrency address.

In one embodiment, a public cryptocurrency address may be used to secure an entire account. For example, in one embodiment a public cryptocurrency address may be required in order for a user to login to an online account. In another embodiment, a public cryptocurrency address may be used to secure part of an online account, such as enabling access to a subset of data associated with the account, or enabling certain features of an online account. For example, a cryptocurrency exchange account may have associated with it a cold storage area (i.e., a vault) for storing information representing cryptocurrency that is stored offline. In one embodiment, access to the cold storage area may be enabled based on a public cryptocurrency address. In another embodiment, a public cryptocurrency address may enable a particular feature of an online account, such as the ability to transfer funds out of an account (cryptocurrency account, bank account, brokerage account, etc.). In yet another embodiment, a public cryptocurrency address may be associated with and enable a single transaction associated with an online account, such as a single transfer of funds out of the account.

In one example, the balance associated with a public cryptocurrency address is conceptually used to “lock” or “unlock” access and/or functionality of at least part of an online account. A public cryptocurrency address and a corresponding private cryptocurrency key are generated using any suitable technique. For example, with bitcoin, a public bitcoin address and private bitcoin key may be generated using the BitAddress.org website. In one embodiment, the user of an online account generates the public cryptocurrency addresses and private cryptocurrency keys in a manner such that only the user knows, holds, and maintains the private cryptocurrency key. In one embodiment, the balance associated with the public cryptocurrency address may be initialized to a non-zero value. For example, in one embodiment a small unit of currency (e.g., a satoshi in bitcoin) may be transferred to the balance of the public cryptocurrency address. In one embodiment, the user of an online account may initialize the balance of the public cryptocurrency address, and in another embodiment, a service provider may initialize the balance to a non-zero value after the user transmits the public cryptocurrency address to the service provider. Once the balance has been initialized to a non-zero value, the only way the balance may be reduced (via an outgoing transfer) is with the private cryptocurrency key which is known, in one embodiment, only by the user of the online account. Accordingly, as long as the balance of the public cryptocurrency address is not reduced, the service provider will deny access and/or features of at least part of the online account. When the user desires access to the secure part of the account, in one embodiment the user employs the private cryptocurrency key to reduce the balance associated with the public cryptocurrency address. When the online account checks the balance for the public cryptocurrency address and sees that the balance has been reduced, the platform enables access to the secure part of the online account. In this manner, the private cryptocurrency key becomes a key used to access at least part of an online account, wherein in one embodiment the private cryptocurrency key may be known only to a single entity (e.g., the user), thereby avoiding the need to store this private security information at the service provider.

The platform can provide a contract generation tool for applicants and investors/lenders to enter into an on-line agreement. The contract has a physical manifestation using e-signing providers such as Docusign, and the physical contract is linked to a blockchain contract with a blockchain address and in case of disputes, the e-signed contract can be enforced using the court system. In other embodiment, when all payments are done using cryptocurrency in advance, only the smart contract is needed to automatically execute and bind the parties. In yet another embodiment that is a hybrid, a computer system includes:
a smart contract with computer-readable program code executable by a processing circuit for:
embedding key data in each term of the smart contract, the key data being associated with a blockchain identification and usable to conduct a transaction, wherein a record of the transaction becomes visible in a transaction ledger;
monitoring the transaction ledger to determine whether a transaction against the blockchain identification has occurred;
applying a contract expert module to interpret contract terms; and
enforcing the smart contract at the machine level if no dispute and otherwise enforcing the smart contract by the platform, the court, an arbitration association, or administrative agency using a contract management system (CMS).

Implementations of transactions can include one or more of the following:
holding a store of value at a bank or escrow to pay for completion of contract terms.
verifying completion of contractual terms using a third-party computer agent.
owners of IoT devices and sensors share generated IoT data in exchange for real-time micropayments.
producing energy produced by IoT energy harvester generates cryptocurrency value registered on the blockchain.
placing a Bill of Lading on a blockchain and terms of the shipping contract are executed in code based on real-time data provided from IoT devices (Smart Agents) accompanying shipping containers.

blockchain in auto supply chains.
providing real-time information from sensor data from various vehicle parts are integrated with blockchain to make real-time decisions and transactions involving services and payments.
recording environmental conditions during the shipment of one or more products and during a change of ownership, checking collected data against each product's corresponding smart contract in the Ethereum blockchain.

Real Estate Property

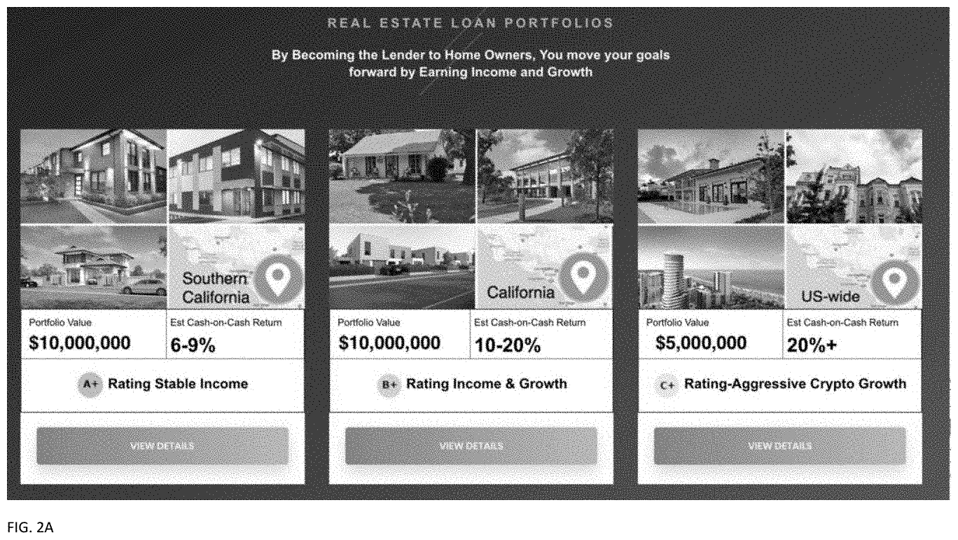

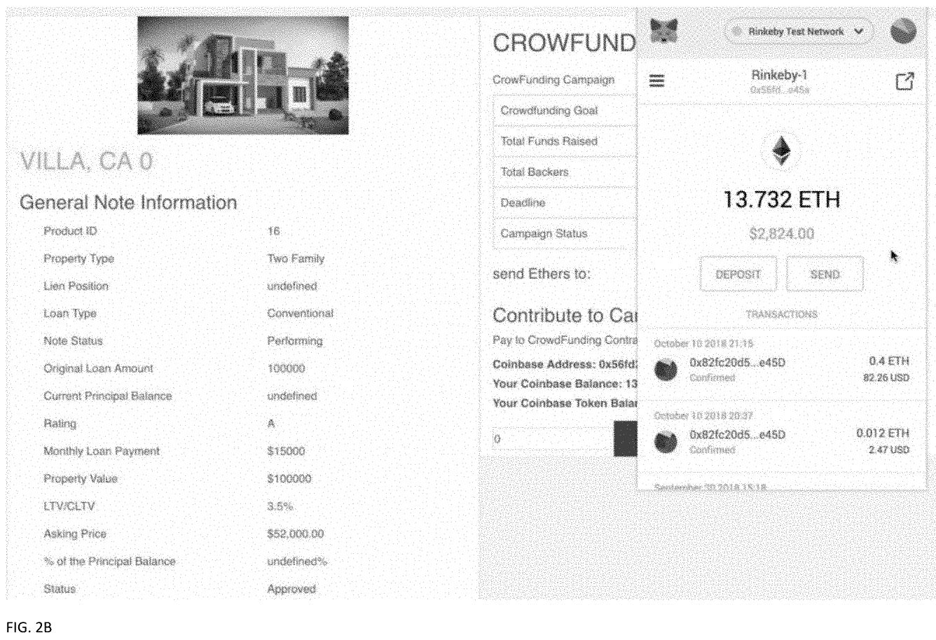

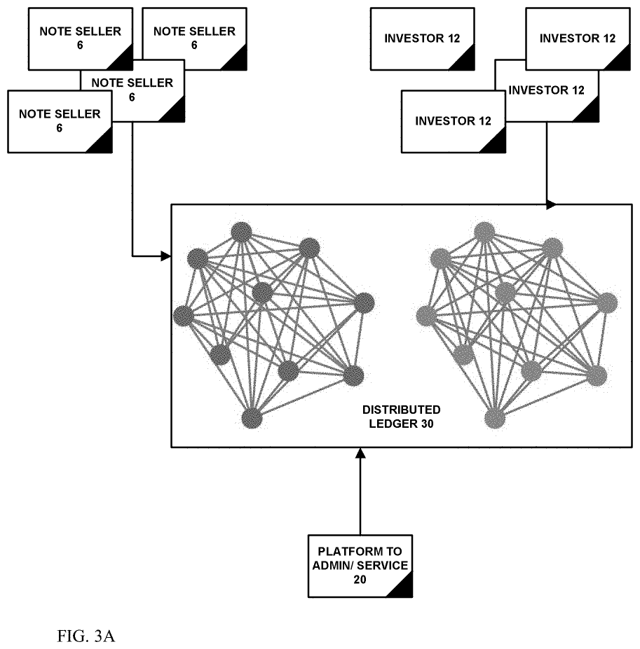

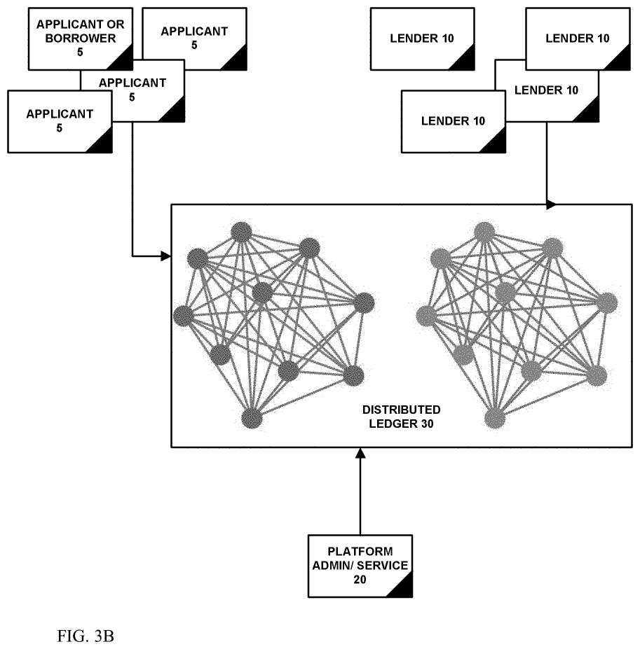

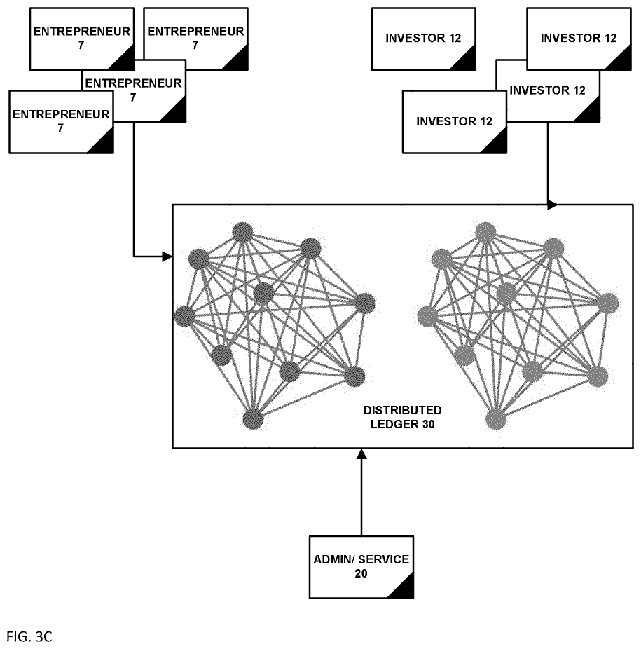

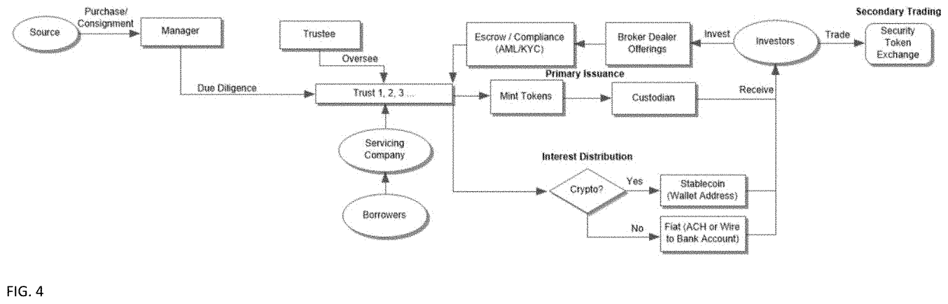

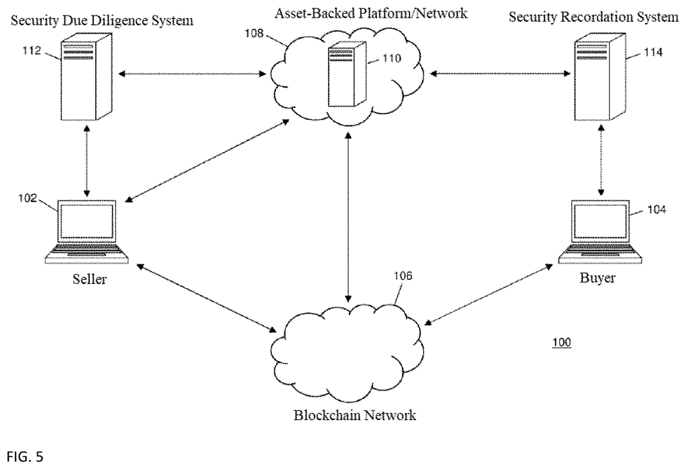

FIG. 2A-2B show exemplary user interface that can be used by investors to tokenize real estate debt. Investors 12 (FIG. 3A, 3C) can also directly invest in real property, alone or with a mortgage lender. In the case of sufficient investors, the house can be purchased using a combination of downpayment by the homeowner and the investors. If needed, a three-way process can be created using a combination of a mortgage, the homeowner's deposit, and an investor group.

The process for funding properties can be two-way or three-way as follows:

Two-Way Financing of Property

Next, a process is described for creating, selling and servicing a contract for financing a homeowner's residential real estate property, in accordance with one embodiment of the present invention. First, the homeowner supplies a down-payment to fund a first portion of the purchase price of the homeowner's residential real estate property. Next, the homeowner pitches to a plurality of investors using the platform of FIG. 1. Interested investors 12 collectively form a contract holder to fund a second portion. At closing of the investment round, the smart contract automatically executes and coins/tokens from investors are transferred to the homeowner or directly to the selling homeowner and such money constitutes PMSI to secure and protect the interest of the contract holder.

The contract holder benefit from equity participation as a contract holder in the homeowner's residential real estate property in return for the contract holder funding the rest of the purchase price as a third portion. The total purchase price of the residential real estate property equals a sum of the first portion and the second portion. The contract imposes a first obligation on the homeowner to make periodic mortgage payments to the contract holder during a period between execution of the contract and a future time (e.g., when the home is sold), and another obligation is imposed on the homeowner to make a future equity participation payment to the contract holder at the future time. The future equity participation payment corresponds to the initial equity participation payment plus a predetermined percentage of the increase in value of the residential real estate property between the time of execution of the contract and the future time. In exchange for the initial equity participation payment. As part of the contract, the homeowner grants at least one lien on the homeowner's residential real estate property to the contract holder in order to secure one or more of the first, second third obligations.

While the process above is for a single home, this process can be extended to fund a group of properties for travelers. The community-based sharing system can be done where a group of properties owned by the community can be funded. The coins/tokens purchased during the coin offering used to raise funding for the group of properties can be used to stay in any of the properties in the portfolio. Proceeds from the token sale will be used to purchase properties globally as part of the portfolio to back the token. This will make the tokens safe to own, and relatively stable in value. Such tokens will provide users with a global array of property choices for business needs and holiday destinations!

Three-Way Financing of Property

Next, a process is described for creating, selling and servicing a contract for financing a homeowner's residential real estate property, in accordance with one embodiment of the present invention. First, the homeowner supplies a down-payment to fund a first portion of the purchase price of the homeowner's residential real estate property, and a mortgage fund a second portion of the purchase price. In the example, the first and second portions of the purchase price together equal half of the purchase price of the home. It will be understood that the first and second portions may correspond to other percentages of the purchase price of the home.

Next, the homeowner pitches to a plurality of investors using the platform of FIG. 1. Interested investors 12 collectively form a contract holder. At closing of the investment round, the smart contract automatically executes and coins/tokens from investors are transferred to the homeowner or directly to the selling homeowner and such money constitutes PMSI to secure and protect the interest of the contract holder.

The contract holder benefit from equity participation as a contract holder in the homeowner's residential real estate property in return for the contract holder funding the rest of the purchase price as a third portion. The total purchase price of the residential real estate property equals a sum of the first portion, the second portion and the third portion. While only 3 portions are discussed, it is understood that other investors can come in as mezzanine investors for 4^{th} portion, and the total purchase price is split among the 4 entities.

In one embodiment, the contract is executed between the homeowner and a mortgage originator. The contract includes a requirement that the homeowner supplies a down-payment to fund the first portion of the purchase price, and a mortgage for financing the second portion of the purchase price. In exchange for the mortgage, the contract imposes a first obligation on the homeowner to make periodic mortgage payments to the contract holder during a period between execution of the contract and a future time (e.g., when the home is sold).

The contract also provides that an initial equity participation payment is supplied by the mortgage originator for funding the third portion of the purchase price. In exchange for the initial equity participation payment, a second obligation is imposed on the homeowner to make a future equity participation payment to the contract holder at the future time. The future equity participation payment corresponds to the initial equity participation payment plus a predetermined percentage of the increase in value of the residential real estate property between the time of execution of the contract and the future time. In exchange for the initial equity participation payment, a third obligation is optionally imposed on the homeowner to make periodic equity participation finance payments to the contract holder during the period between execution of the contract and the future time.

As part of the contract, the homeowner grants at least one lien on the homeowner's residential real estate property to the contract holder in order to secure one or more of the first, second third obligations.

Creation of Asset Backed Securities and Repackaging

A security can be created by pooling rights under the contract with rights under other contracts sold to a plurality of other homeowners each of whom owns at least one of a plurality of residential real estate properties. In one embodiment, security is repackaged and sold to an institutional investor in a secondary market and may be performed by one or more mortgage backed securities issuers such as Fannie Mae or Freddie Mac. The security provides the institutional investor with at least one of: (i) a right to receive the periodic mortgage payments from each of the homeowners, (ii) a right to receive the periodic equity participation finance payments from each of the homeowners; and (iii) for each of the plurality of residential real estate properties, a right to receive the future equity participation payment associated with the residential real property at the time of a future sale of the residential real estate property. Securities sold may be categorized into types according to risk profile, geographic exposure, home price, exposure, duration, etc.

The plurality of contracts included in the security are serviced by managing at least one of: the periodic mortgage payments, the periodic equity participation finance payments, and the equity participation payments from the homeowners. The servicing is performed in exchange for a servicing fee.

In one embodiment, the security sold to the institutional investor provides the institutional investor with a right to receive the periodic mortgage payments from each of the homeowners, the periodic equity participation finance payments from each of the homeowners, and for each of the plurality of residential real estate properties, the right to receive the future equity participation payment associated with the residential real property at the time of the future sale of the residential real estate property.

In a further embodiment, first and second securities are created and sold to institutional investors in by pooling rights under the contract with rights under other contracts sold to a plurality of other homeowners each of whom owns at least one of a plurality of residential real estate properties, and selling the first and second securities, respectively, to first and second different institutional investor in a secondary market. The first security provides the first institutional investor with a right to receive the periodic mortgage payments from each of the homeowners. The second security provides the second institutional investor with the right to receive the periodic equity participation finance payments from each of the homeowners, and for each of the plurality of residential real estate properties, the right to receive the future equity participation payment associated with the residential real property at the time of the future sale of the residential real estate property. In one version of this further embodiment, after execution of the contract, the homeowner periodically makes a single payment that includes both one of the periodic mortgage payments and one of the periodic equity participation finance payments, and a servicing agent disburses a portion of the single payment covering the mortgage payment to the first institutional investor and a portion of the single payment covering the equity participation finance payment to the second institutional investor.

In a further embodiment, the homeowner pledges a portion of the homeowner's down-payment in the residential real estate property to the contract holder as security in the event that the homeowner's residential real estate is later sold at a loss. Optionally, the homeowner purchases a second contract having a premium payable by the homeowner, an expiration date that is a date certain, a predetermined strike threshold, and a fixed cash-settled payout triggered by a reduction in value of an index below the predetermined strike threshold between a first time and the expiration date; wherein the index benchmarks at least one characteristic of a plurality of residential real estate properties of the same type as the homeowner's property and in a common geographic area as the homeowner's property.

A further security is then created by pooling the second contract with other contracts sold to a second plurality of homeowners, and selling the further security to a further institutional investor in a secondary market. The further institutional investor receives at least a portion of the premium paid by the second plurality of homeowners, and the homeowner receives the fixed cash-settled payout from the further institutional investor if the value of the index has decreased below the predetermined strike threshold between the first time and the expiration date. The homeowner may use the second contract as a hedge to offset potential losses to the homeowner that would result if the homeowner's residential real estate is later sold at a loss.

In another embodiment, a contract is executed between the homeowner and an originator in which the mortgage originator purchases an equity portion of the residential real estate property from the homeowner. In connection with the purchasing, the homeowner grants a lien on the homeowner's residential real estate property to the originator in order to secure a future payment obligation of the homeowner. The future payment obligation has an amount that is determined in accordance with a value of the purchased equity portion of the homeowner's residential real property at a time of the future payment (e.g., when the home is sold). The security is created by pooling the contract with other contracts sold to a plurality of other homeowners each of whom owns at least one of a plurality of residential real estate properties. The security is repackaged and sold to an institutional investor in a secondary market. The security provides that, upon a sale of each given residential real estate property, the institutional investor has a right to receive a payment corresponding to the value of the purchased equity portion of the given residential real property at the time of the sale. Such securities may be categorized into types according to risk profile, geographic exposure, home price, exposure, duration, etc.

FIG. 4 shows an exemplary process where real estate note assets held in one or more trusts by a trustee are managed by a manager and note payments from borrowers of the notes are collected/serviced by a servicing company. The trust in turn issues tokens or securities to investors through broker/dealers who are vetted through AML/KYC process. Once accepted, tokens are minted and held by a custodian or send to the investors, who in turn can trade the tokens on a security token exchange. Further, optionally, interests may be paid using crypto through stablecoin or paid as fiat through ACH or wire to a bank account.

System for Use of Blockchain Cryptocurrency for Asset-Backed Transactions

FIG. 5 illustrates a system 100 for the managing of blockchain and fiat currency and use thereof in payment transactions for asset-backed transactions, including the linkage of verified identifies to blockchain-based transactions and assessing of risk in blockchain-based transactions.

In the system 100, a blockchain transaction may occur between the computing device of an asset seller 102 and the computing device of a buyer 104. The seller 102 can sell the actual asset such as a real estate property, or can sell a debt instrument secured by the property such as a mortgage, lien, or note, for example.

The blockchain transaction may be processed by one or more computing devices that comprise a blockchain network 106. The blockchain network may receive at least a destination address (e.g., associated with the buyer 104) and an amount of blockchain cryptocurrency and may process the transaction by generating a block that is added to a blockchain that includes a record for the transaction.

The computing device of the seller 102 may digitally sign the transaction request using an encryption key stored in the computing device, such as stored in an electronic wallet. The digital signature may be, include, or otherwise be associated with an address that is generated using the encryption key, which may be associated with blockchain cryptocurrency in the blockchain, and may be used to transfer blockchain cryptocurrency to an address associated with the buyer 104 and/or their computing device. In some embodiments, the address may be encoded using one or more hashing and/or encoding algorithms, such as the Base58Check encoding algorithm. The generation and use of addresses for the transfer of blockchain cryptocurrency in blockchain-based transactions using the blockchain network 106 will be apparent to persons having skill in the relevant art.

The system 100 may also include a blockchain-based trading platform or network 108. The payment network 108 may be configured to process payment transactions using methods and systems that will be apparent to persons having skill in the relevant art. In the system 100, the payment network 108 may also include a processing server 110. The processing server 110, discussed in more detail below, may be configured to authorize blockchain-based transactions using the payment network 108 and traditional payment rails, may be configured to link blockchain transactions with privately verified identities including fiat and/or blockchain transaction accounts, and may be configured to provide risk and sanction assessments for blockchain transactions.

The seller 102 may be associated with a security due diligence system 112. The system 112, discussed in more detail below, may be a computing system of a mortgage insurer or an original note issuing bank, that issues one or more transaction accounts to the seller 102. The seller 102 may also have various accounts including one or more fiat currency transaction accounts, one or more blockchain cryptocurrency transaction accounts, one or more combined currency transaction accounts, or any combination thereof.

The buyer 104 may be associated with an acquirer 114. The acquirer 114 may be a computing system of a financial institution, such as an acquiring bank, that issues one or more transaction accounts to the buyer 104. The acquirer 114 may be the equivalent of the system 112, but with respect to the buyer 104 rather than the seller 102. In some instances, the system 112 and the acquirer 114 may be the same financial institution. For example, the system 112 may provide transaction accounts to both the seller 102 and the buyer 104.

The seller 102 may conduct a blockchain transaction with the buyer 104. As part of the blockchain transaction, the buyer 104 may generate a destination address for receipt of payment of blockchain cryptocurrency. The destination address may be generated using an encryption key stored in the computing device of the buyer 104. The encryption key may be part of a key pair, such as a public key corresponding to a private key stored in the computing device. In some instances, the buyer 104 may provide the public key to the seller 102, and the seller 102 may generate the destination address. A transaction request may then be submitted by the seller 102 for payment of an agreed-upon blockchain cryptocurrency amount to the destination address provided by the buyer 104. In a traditional blockchain transaction, the transaction request may be submitted by the computing device to the blockchain network 106. In the present system 100, the transaction request may be submitted to the processing server 110 of the platform/network 108.

The transaction request may be a transaction message and may be formatted based on one or more standards for the governance thereof, such as the International Organization for Standardization's ISO 8583 standard. In some instances, the processing server 110 may receive the transaction request and may generate a subsequent transaction message. The transaction message may include a plurality of data elements, which may be associated with specific usage based on the one or more standards. For example, the data elements may include a data element for the storage of transaction amount and also include at least one data element reserved for private use. In the system 100, the transaction message submitted to the processing server 110 may include a data element reserved for private use that includes data associated with the desired blockchain transaction.

For instance, the data element reserved for private use may include a network identifier, a transaction amount, and at least one of: a public key and an address identifier. The network identifier may be associated with a blockchain network 106 associated with the blockchain cryptocurrency being transferred in the transaction. The network identifier may be used by the processing server 110 to identify the associated blockchain network 106 for posting of the eventual blockchain transaction. In addition, by using different identifiers, the processing server 110 may be configured to perform the functions discussed herein for a plurality of different blockchain currencies and associated blockchain networks 106.

The transaction amount may be an amount of blockchain cryptocurrency being transferred as a result of the transaction. The address identifier may be the destination address for the blockchain cryptocurrency, as provided by the buyer 104 or generated by the seller 102 using information provided by the buyer 104 (e.g., their public key). In instances where the data element includes a public key (e.g., associated with the buyer 104) instead of an address identifier, the processing server 110 may be configured to generate an address identifier using the public key. In some instances, the address identifier may be encoded using one or more hashing and/or encoding algorithms, such as the Base58Check algorithm.

In some embodiments, the transaction message may include information for multiple buyers 104. In such an embodiment, the data element reserved for private use may include multiple transaction amounts and associated address identifiers and/or public keys. In another embodiment, the transaction message may include multiple data elements reserved for private use, with each one including a transaction amount and a different address identifier and/or public key associated with a buyer 104. In some instances, one of the buyers 104 may be the seller 102. For example, the blockchain transaction may include a remainder amount of blockchain cryptocurrency to be retained by the seller 102, and may thereby include a transfer from an input address to a destination address of the seller 102, as will be apparent to persons having skill in the relevant art.

In some embodiments, the data element reserved for private use, or an alternative data element reserved for private use in the transaction message, may include input information associated with the seller 102. The input information may include a transaction identifier associated with a prior blockchain transaction as well as a public key associated with the seller 102 and a digital signature. The digital signature may be generated using a private key corresponding to the public key and may be used for verification of ownership of a blockchain cryptocurrency amount associated with the transaction identifier by the seller 102, such that the seller 102 is authorized to transfer the blockchain cryptocurrency in the requested transaction.

In some instances, the transaction message may be submitted to the processing server 110 by the seller 102. In other instances, the seller 102 may provide the transaction information to the insurance or bank 112, which may generate and submit the transaction message to the processing server 110. Once the transaction message is received by the processing server 110, the processing server 110 may perform additional functions, such as an assessment of risk or sanctions as discussed in more detail below. A corresponding blockchain transaction may then be processed using the blockchain network 106 based on the information included in the data element(s) reserved for private use. In some embodiments, the blockchain transaction may be initiated by the processing server 110. In other embodiments, the processing server 110 may provide the transaction message or data included therein to the insurance or bank 112, which may initiate the blockchain transaction, such as after evaluating risk for the transaction, assessing if the seller 102 has sufficient rights in the asset being sold, or sufficient security for the transaction, and etc., as discussed below.

For instance, as discussed in more detail below, the system 112 may be a title insurance company or a bank which holds information on the, which may include the storage of currencies associated with the seller 102. The system 112 may store a transaction account of blockchain cryptocurrency associated with the seller 102 such that, when a transaction is attempted by the seller 102, the system 112 may verify the authenticity of the asset being sold. Optionally, the system 112 can verify the available funds of the seller 102 as bonds to backup the seller's guarantees prior to initiating the blockchain transaction, which may be before submitting the transaction message to the processing server 110 and/or before submitting a transaction request to the blockchain network 106.

In another example, the system 112 may assess a risk for the transaction based on an evaluation provided by the processing server 110 or performed by the system 112, such as based on the seller available funds, credit history, or other fraud, sanction, and/or risk considerations that will be apparent to persons having skill in the relevant art. In some embodiments, the platform/network 108 with system 110 may assess a risk for the transaction prior to processing by the blockchain network 106. For instance, the network 108 may evaluate the reliability of the seller 102, an expectation of fraud, etc. based on data provided by the system 112, processing server 110, or third-party entity, as discussed in more detail below. In some instances, the seller 102 may decline the use of payment protection in exchange for a discount offered by the buyer 104 (e.g., a merchant), which may be beneficial for the merchant 104 as a result of reduced fees. In other instances, the buyer 104 may decline the use of risk assessments and other protections for a transaction.

In some embodiments, the system 112 and/or processing server 110 may be further configured to store private keys on behalf of payers 102 and/or buyers 104. In such embodiments, the private key may be stored such that the system 112 and/or processing server 110 may initiate and digitally sign blockchain transactions on behalf of a seller 102 such that the seller 102 does not need to retain possession of a computing device for use in blockchain transactions. For example, the system 112 may store the private key on behalf of the seller 102 and any transaction identifiers associated with the seller 102 (e.g., in their blockchain cryptocurrency account) and may be configured to generate the digital signature and include the generated signature and transaction identifier in transaction messages for blockchain transactions involving the seller 102.

In some embodiments, the processing server 110 may be further configured to link blockchain transactions with privately verified identities, such as with the seller 102, buyer 104, or transaction accounts associated thereof. For example, the processing server 110 may store account information for transaction accounts associated with the seller 102 (e.g., held by the system 112) and the buyer 104 (e.g., held by the acquirer 114), which may include address identifiers. The processing server 110 may then associate blockchain transactions with the stored account information using the account identifiers included therein and account identifiers included in data elements in received transaction messages. The processing server 110 may thereby store historical transaction data for individuals for blockchain transactions. In instances where an individual may have a combined fiat and blockchain cryptocurrency account, the processing server 110 may, as a result, store transaction history for a consumer's fiat and blockchain transactions for real estate investments.

Generally, real estate investments can be classified into three categories based on the debt & equity structure:

A) All-equity: Buying a property entirely with cash (i.e., owning 100 percent of the equity) is the simplest and most conservative method of investing in real estate. This type of all-cash investments is commonly used for highly risky or highly illiquid investments where affordable loans are not available. In this case, returns for all-equity investments are referred to as “unlevered” returns.

B) Debt & equity: Using a combination of debt and equity is the most common way to invest in the real estate. In this case, the owner of the property has a mortgage loan with a lender. If the borrower defaults on this loan, the lender can foreclose and become the new owner of the property. The loan amount is limited by the lender's risk tolerance, and often constrained by loan-to-value, debt coverage ratio, debt yield, or other metrics.

C) Senior debt, junior debt, & equity: In certain cases, real estate investments may involve a subordinate debt, aka “junior” or “mezzanine” debt that falls between the senior debt and the equity in the capital structure. The senior lender has first priority and the subordinate lender has the second priority. The basic mechanics of mezzanine debt are similar to the senior debt. At closing, the mezzanine lender funds cash into escrow to capitalize the property acquisition. The borrower pays the mezzanine lender interest during the loan term and repays the remaining balance at the end of the term. Like senior debt, mezzaine often has loan fees and prepayment penalties if it is paid off early.

In the Blockchain Network, nodes are the backbone of the blockchain network. Nodes form a peer-to-peer network and collaborate with each other to maintain the network in a consistent state. Typically, nodes validate and execute transactions in the network as per the consensus protocol. Types of blockchain networks include pubic (permission-less) and private (permissioned). Depending on the type of blockchain network, nodes can serve various roles such as miners, validators, orderer, etc.

Tokens represent assets of value that are associated with some form of ownership. Blockchain enables “Tokenization” of assets that are tangible (i.e., physical asset such as a cash, car, house, cash, etc.) and in-tangible (non-physical assets such as copyrights, patents, intellectual property, etc.). In the blockchain network, tokens are secured using cryptographic hash algorithms and must be signed by the owner for secured identity. Tokens security measures involve authentication and authorization, which are typically achieved with Public Key Infrastructure (PKI) using private/public key cryptography. BitCasas platform offers two different tokens: utility tokens and asset-backed security tokens.

Ledger (aka Distributed Ledger) is the core building block in the blockchain network and serves as a decentralized and distributed database. A batch of transactions are recorded in the ledger in the order of occurrence as a hashed block. Fundamentally, the ledger consists of a chain of hashed blocks of transactions with each block referring to the previous block. The ledger is shared across the blockchain network and thus every node has a copy of the ledger. New transactions to the ledger are recorded in the blockchain network through use of an algorithm to arrive at a consensus among a certain number of nodes. The consensus algorithm consists of a set of rules and conditions, which governs how new transactions are appended to the ledger. In our platform, all transactions will be recorded on the public blockchain network (e.g., Ethereum, NEO).

Consensus requires every new transaction must be validated and accepted by a certain number of nodes on the network based on a protocol (i.e., algorithm). Then, the current state of ledger will be updated with the new transactions. All participants in the blockchain network will be synchronized with the current copy of the ledger and therefore the data on the ledger is immutable. Commonly used consensus protocols include Proof-Of-Work (PoW), Proof-of-Stake (PoS), Practical Byzantine Fault Tolerance (PBFT), etc.

Smart Contract is a software code that contains a business logic (or contract) that affects the state of a digital asset (Tokens) in terms of its value and ownership. When smart contracts are executed, it performs business operations that act on the state of the ledger. Smart contracts form the foundation of a blockchain-based business and thus well-defined contracts are critical for a robust business model. Smart contracts can be secured through encryption and digitally signed by owners. In our business, Smart contracts are used for automating workflows including on-going token sale, dividend distribution, due diligence, cash liquidation terms, etc.

Oracles provide a transaction proof of the data coming from external sources. Typically, oracles are provided by a third-party service as a secured transaction. Essentially, oracles extract the information and push the data into the smart contract and thus eliminates the need for smart contracts interactions with the public feed. In our platform, oracles will be used to feed information such as interest rate, property valuation (i.e. Zillow), market conditions etc. into the smart contracts.

In one implementation, data pertinent to user profiles, portfolio information, and historical performance are stored in a traditional database that is based on a client-server network architecture. A user (known as a client) can modify data that is stored on a centralized server and can perform four functions on data: Create, Read, Update, and Delete (collectively known as the CRUD commands). A designated authority maintains control of the database and authenticates a user's credentials before providing access to the database.

The platform of FIG. 5 leverages the benefits of blockchain-based tokens or tokens in real estate assets. The use of tokens enables liquidity to investors, smart contract automated investment choices, and traceability that blockchain is famous for, among others. In the fourth paradigm, aggregating digital consumer profiles has resulted in the emergence of “Big Data,” a leveraging tool that is reshaping industry practice and processes, as well as approaches to regulatory oversight. Mortgages are incredibly data rich with information on borrower income, employment, assets, credit and usage, and property data from the home to be financed and comparable properties used to establish value. Instead of mining Big Data, most mortgage companies have historically used loan level data very narrowly for tasks such as client prospecting and loss forecasting. Over the last decade access to vast amounts of raw data has initiated an avalanche of new technologies and tools that apply business intelligence and analytics to provide mortgage companies a set of reliable predictors, beyond credit-driven data, to better identify prospects. Our platform allows both investors and the industry to leverage the data collection component of the loan origination process to capture institutional knowledge and consumer financial information. This approach can replace existing methods to assess creditworthiness and loan performance. Optimizing data will equate to long-term business opportunities for everyone from Silicon Valley to Wall Street and Main Street.

While the goal of the mortgage industry has not changed—providing consumers with suitable, sustainable, and well-priced mortgages—the means to achieve the goal has. The key to harnessing disruption lies in the willingness of incumbents and new entrants to bolster their transformative capabilities to eliminate inefficiencies, reduce costs, and improve customer satisfaction. Disruptive movements, led by companies like Uber, Amazon, Google, and others have transformed consumer service industries to leverage technology, improve the consumer experience, and enhance business efficiency. By embracing disruption, our platform can maximize the potential available in the existing housing market, such as a diverse mix of tech-savvy consumers and emerging crowdfund capital providers enabled by our tokens.

The methods and systems discussed herein accordingly provide for the processing of blockchain transactions using transaction messaging and traditional payment networks, which may be provide significant benefits to consumers and financial institutions that are currently unavailable in blockchain transactions. By using traditional payment rails and transaction messages, which are highly regulated and secure, transaction information may be transmitted at a higher level of security than methods currently used in blockchain transactions. In addition, the storage of private keys in financial institutions and/or payment networks may enable consumers to engage in blockchain transactions without being in constant possession of a computing device that stores their private keys. This may reduce the risk of theft of the consumer's blockchain cryptocurrency by trusting the data to financial institutions and payment networks that already specialize in the storage of sensitive financial information, and that are well equipped to transmit and analyze transaction messages.

In addition, by processing blockchain transactions using payment networks, payment networks may be able to evaluate the likelihood of fraud and assess risk for blockchain transactions using existing fraud and risk algorithms and information that is available to payment networks, such as historical fiat and blockchain transaction data, credit bureau data, demographic information, etc., that is unavailable for use in blockchain networks 106. As a result, sellers 102 and buyers 104 may engage in blockchain transactions with added safeguards against fraud and risk.

Therefore, the methods and systems discussed herein can provide for significant improvement over the traditional processing of blockchain transactions via the use of fractional reserves, transaction messages, risk evaluation, and payment network processing, by increasing consumer security, significantly decreasing processing time, and providing significantly increased defense against fraud.

Processing Server

FIG. 6 illustrates an embodiment of the processing server 110 of the system 100. It will be apparent to persons having skill in the relevant art that the embodiment of the processing server 110 illustrated in FIG. 6 is provided as illustration only and may not be exhaustive to all possible configurations of the processing server 110 suitable for performing the functions as discussed herein. For example, the computer system 1400 illustrated in FIG. 14 and discussed in more detail below may be a suitable configuration of the processing server 110.

The processing server 110 may include a receiving unit 202. The receiving unit 202 may be configured to receive data over one or more networks via one or more network protocols. The receiving unit 202 may be configured to receive transaction messages from issuers 112, acquirers 114, sellers 102, and other entities that are formatted pursuant to one or more standards for the interchange of transaction messages, such as the ISO 8583 standard, and using communication protocols associated thereby. The receiving unit 202 may also receive transaction requests from issuers 112, acquirers 114, and/or payers 102. The receiving unit 202 may also be configured to receive account information for transaction accounts, which may include fiat currency and blockchain cryptocurrency accounts, from financial institutions, such as the system 112 and the acquirer 114. The receiving unit 202 may be further configured to receive any additional data suitable for performing the functions disclosed herein, such as data that may be used in the risk assessment of a blockchain transaction, such as credit bureau information, demographic characteristics, etc.

The processing server 110 may also include a processing unit 204. The processing unit 204 may be configured to perform the functions of the processing server 110 discussed herein as will be apparent to persons having skill in the relevant art. When a transaction request for a blockchain transaction is received by the receiving unit 202, the processing unit 204 may be configured to identify data included in the transaction request and generate a transaction message based thereon. The transaction message may be generated for compliance with one or more standards, such as the ISO 8583 standard, and may include a plurality of data elements. The data elements may include a data element configured to store a transaction amount and a data element reserved for private use. The processing unit 204 may be configured to store a zero value in the data element configured to store a transaction amount, and may be configured to store at least a network identifier or encoded value based thereon, an address identifier, and a transaction amount in the data element reserved for private use.

In some embodiments, the processing unit 204 may be further configured to generate the address identifier. In such an embodiment, the processing unit 204 may use a public key included in the received transaction request to generate a destination address. The destination address may be the address identifier, or, in some instances, the destination address may be encoded using one or more hashing and/or encoding algorithms, such as Base58Check encoding, to generate the address identifier.

The processing server 110 may also include a transmitting unit 206. The transmitting unit 206 may be configured to transmit data over one or more networks via one or more network protocols. The transmitting unit 206 may transmit data requests to the system 112, acquirer 114, seller 102, or other entities. The transmitting unit 206 may also be configured to transmit generated transaction messages to financial institutions, such as the system 112 and the acquirer 114, using the payment network 106. In some embodiments, the transmitting unit 206 may also transmit blockchain transaction requests to blockchain networks 106 based on information received by the receiving unit 202 and generated by the processing unit 204 for use in blockchain transactions. For example, the transmitting unit 206 may transmit a transaction message to the system 112, which may approve the corresponding blockchain transaction as indicated in an approval received by the receiving unit 202. The transmitting unit 206 may then transmit the blockchain transaction to the blockchain network 106 using methods and systems that will be apparent to persons having skill in the relevant art.

In some embodiments, the processing server 110 may also include an account database 208. The account database 208 may be configured to store a plurality of account profiles 210. Each account profile 210 may include data related to a consumer (e.g., the seller 102, buyer 104, etc.) or a transaction account associated thereof, including at least an account identifier, a fiat currency amount, and one or more blockchain cryptocurrency amounts. Each blockchain cryptocurrency amount may be associated with a blockchain network 106. The account identifier may be a unique value associated with the account profile 210 used for identification thereof, such as a transaction account number, wallet identifier, device identifier, username, e-mail address, phone number, etc. In some embodiments, the account identifier may be a private key. The account profile 210 may also include a plurality of associated address identifiers used in blockchain transactions associated with the related consumer and/or transaction account.

In such an embodiment, the receiving unit 202 may be further configured to receive a transaction message for a blockchain transaction. The transaction message may include a data element configured to store a personal account number that includes a specific account identifier and a data element reserved for private use that includes at least a network identifier and a transaction amount. The processing unit 204 may be configured to identify a specific account profile 210 stored in the account database 208 that includes the specific account identifier. The processing unit 204 may be further configured to identify a risk value for the blockchain transaction. The risk value may be based on the transaction amount included in the data element reserved for private use and data included in the identified specific account profile 210.

For example, the risk value may be based on a correspondence between the transaction amount and a blockchain cryptocurrency amount of the specific account profile 210 that is associated with a blockchain network 106 corresponding to the network identifier included in the data element reserved for private use. In some instances, the risk value may also be based on a corresponding amount of fiat currency, such as based on one or more conversion rates associated with conversion of the fiat currency to/from the respective blockchain cryptocurrency.

The processing unit 204 may be further configured to determine authorization of the blockchain transaction based on the identified risk value. For example, if the processing unit 204 identifies that the blockchain transaction has a high-risk value (e.g., indicating a high likelihood of fraud, sanctions, inability to pay, etc.), the processing unit 204 may determine that the transaction should be denied. The processing unit 204 may modify the transaction message to include the determination, and the transmitting unit 206 may be configured to transmit the transaction message to the system 112 and/or acquirer 114. The financial institution may then proceed in the processing of the transaction accordingly based on the determination. As part of the processing, the receiving unit 202 may receive an authorization response from the financial institution, and the transmitting unit 206 may forward the response as a reply to the received transaction message, and may also (e.g., if the transaction is approved) initiate the blockchain transaction with the blockchain network 106.

In some embodiments, the processing unit 204 may be further configured to link blockchain transactions with account profiles 210 stored in the account database 208. In such an embodiment, transaction messages received by the receiving unit 202 for blockchain transactions may include at least a first data element configured to store a personal account number, a second data element configured to store a merchant identifier, and a third data element, which may be reserved for private use, configured to store at least blockchain network identifier. The processing unit 204 may identify a first account profile 210 where the included account identifier corresponds to the personal account number and a second account profile 210 where the included account identifier corresponds to the merchant identifier.

The receiving unit 202 may also receive a transaction notification indicative of a blockchain transaction processed using a blockchain network 106 associated with the blockchain network identifier included in the third data element of the received transaction message. The transaction notification may include at least a transaction identifier and an address identifier. The address identifier may be associated with the identified first account profile 210 or the identified second account profile 210. The processing unit 204 may then store a linkage between the transaction identifier and the account identifier included in the account profile 210 associated with the address identifier. In some instances, the linkage may be stored via storage of the transaction identifier in the corresponding account profile 210, which may thereby be used in future blockchain transactions involving the associated transaction account. In some instances, the transmitting unit 206 may transmit the transaction identifier to a financial institution associated with the linked account, such that the financial institution may store the transaction identifier for use in future blockchain transactions. In some cases, the processing unit 204 may store transaction data included in the transaction message in the first and/or second account profiles 210.

In some embodiments, the processing server 110 may further include a transaction database 212. The transaction database 212 may be configured to store a plurality of transaction data entries 214. Each transaction data entry 214 may include data related to a payment transaction, which may be a fiat currency transaction or a blockchain cryptocurrency transaction. Each transaction data entry 214 may include a transaction message, transaction notification, and/or data included therein, such as transaction times and/or dates, transaction identifiers, source addresses, destination addresses, transaction amounts, merchant data, consumer data, product data, loyalty data, reward data, etc. In some instances, transaction data entries 214 may be stored in an account profile 210 related to a transaction account involved in the associated payment transaction.

The processing server 110 may also include a memory 216. The memory 216 may be configured to store data suitable for use by the processing server 110 in performing the functions disclosed herein. For example, the memory 216 may store one or more hashing algorithms for encoding address identifiers, one or more rules for the generation of address identifiers, blockchain network data, rules and/or algorithms for calculating risk values, fiat and blockchain cryptocurrency conversion algorithms or data, etc. Additional data that may be stored in the memory 216 will be apparent to persons having skill in the relevant art.

Real Estate Debt Decentralized Application (dApp)

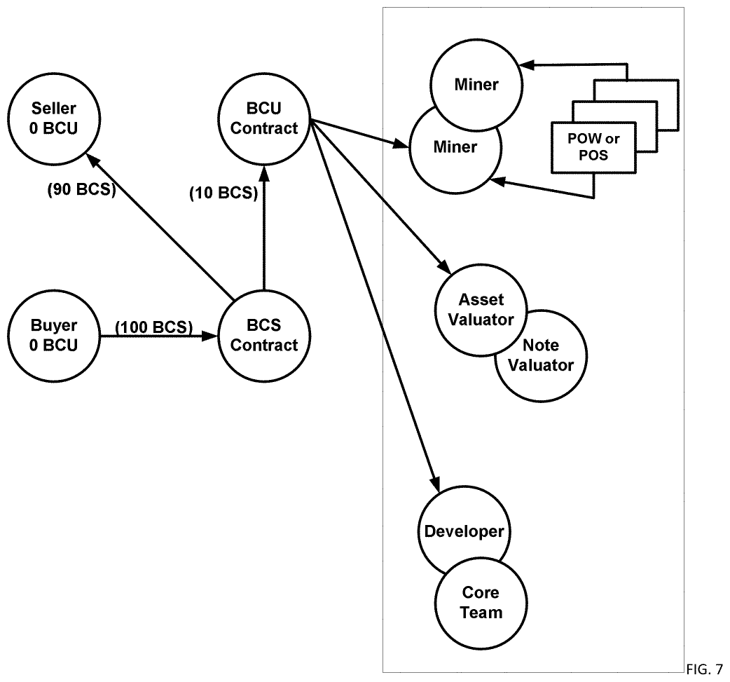

FIG. 7 shows an exemplary dApp called BitCasas that enables trading of asset-backed instruments such as mortgages including first and second liens, among others. In this system, every time a note seller wants to use the BitCasas service, the note seller activates a smart contract: the “Security Contract”. The seller uploads description and supporting documents such as the debt agreement, the mortgage, payment history, debtor information, and the list price for the note. The smart contract would contain the asked price, max discount allowed, smart contract trading logic, and address to off-chain documentation of the note. Documentation about the note can be stored in storage such as Amazon or Microsoft storage or IPFS, among others. If the buyer sends an offer that is within the max allowed discount, the smart contract would execute and automatically transfers the purchase tokens to the seller and the title of the purchased note to the buyer. The note seller also supplies gas to power the smart contract. For example, the asked for price can be in BitCasas Asset-backed Security Tokens (BCS), and the gas can be in BitCasas Utility Tokens (BCU).

While Ethereum is the most popular platform for writing smart contracts, it is not the only one. The following are some of the other platforms used for writing smart contracts:

Script in Bitcoin—Script has limited capabilities when processing documents. Bitcoin features a non-Turing complete scripting language, which allows for specifying under which conditions a transaction can be redeemed. The scripting language is quite limited, as it only features some basic arithmetic, logical, and crypto operations (e.g. hashing and verification of digital signatures).

Automated Transactions is another Turing complete smart contract language, used in cryptocurrencies like Burstcoin and Qora. An example of its usage is atomic cross-chain trading. Atomic cross-chain trading enables two parties, who own coins/tokens in different cryptocurrencies, to exchange them without need for a third, trusted party.

NXT: NXT is a public blockchain platform that contains a limited selection of templates for smart contracts.

Chain—Chain provides enterprise-grade blockchain infrastructure with SDKs in Java, Ruby, and NodeJS.

NEO: NEO is a public blockchain network that is focused on tokenizing assets for creating a smart economy.

In one example shown in FIG. 7, a buyer activates the smart contract and buys the seller note by sending the purchase price for the note, and the following happens:
The title to the note is transferred to buyer, and the seller gets, for example, 90% of the BCS stored in the BitCasas Security Contract
The remaining 10% of the BCS are sent to the BitCasas Utility Contract in this 90-10 example.
The Utility Contract splits the 10% Security Tokens it contains among all the members of the network, proportionally to the amount of Utility Tokens in they own.

Miners create and earn a certain amount of BCU and BCS every time miners mine a block of transactions and update the network. The mining can be proof of work (PoW) or Proof of Stake (PoS), among others. To enhance the network, developers earn Utility Tokens every time a code update is submitted for the app and the network accepts the update. As a result, miners and developers not only get BCS but also get tokens for their work. And because these tokens are proportional to the amount of Utility Token they own, they need to keep mining to keep their percentage.

To use the service the seller needs BCU, which are available from various sources: Note Trader, Miner, Developer . . . in exchange of any currency, be it Dollars, Euros, Yens, or even other cryptocurrencies.

In one embodiment, the platform/network engineers build the decentralized application and then pre-mine early tokens. For example, the platform can create a time-bound smart contract ahead of platform availability. This contract will give each new account predetermined Security and Utility Tokens. The engineers then create accounts and deposits the early tokens just before the end on the time bound smart contract. The resulting BCU to users and the BCS are then available for their work during the offering period.

In addition to developers and the core team of the platform/network 108, the community of asset valuation/note valuation experts is important. There are many similarities between investing in real estate and investing in notes, including evaluating the collateral, and working with title, escrow and insurance companies. The platform scales quickly and efficient through its community. Functions provided by the community include verifying the old adage of real estate, “location, location, location” also applies to notes, as well as, “collateral, collateral, collateral.” Value the underlying collateral of the note investment as if you will own the property (because you just might). The community evaluator can also get an independent interior appraisal, visit or drive by the property. The community valuator can review a lender's policy to insure the note will record in the desired lien position. For existing note purchases, the evaluator can review the existing final title policy (not a preliminary report) and obtain an endorsement from the title company when the assignment is issued at closing. For an existing note, there is less for escrow to do because the note has already been funded. Instead of a traditional escrow, many purchasers of existing notes use a sub-escrow which is managed by the title company. The title company obtains from the note seller, the endorsed promissory note and a notarized assignment. The buyer sends the note purchase funds to title. When the documents and funds are in hand at the title sub-escrow, the assignment is recorded, along with the selected title endorsement(s) and the funds are transferred to the note seller. Note valuators should make sure the borrower has appropriate insurance for the collateral and that the note investor is listed as the Mortgagee on the Evidence of Insurance certificate issued by the insurance company. When listed as a Mortgagee on the insurance policy, the insurance company knows to issue a check to both the Mortgagee and the Borrower. In addition, if the policy is changed or canceled, the Mortagee is notified and can take corrective action.

The valuator also evaluates the borrower's credit and capacity to make regular payments, which is equally as important as the value and quality of the collateral. The process of evaluating the borrower's credit and ability to pay is called “underwriting” the loan. In purchasing real estate, there is typically a purchase agreement and a Deed. The purchase agreement details the terms of the purchase and the deed is recorded to put the public on notice of the new owner, and that the transaction closed. In a note purchase, there is also a purchase and sale agreement which spells out the terms of the note purchase, but instead of a Deed, the instrument that is recorded is called an Assignment. The previous note holder is assigning the beneficial interest of the note to the new note owner.

When a note investor is not paid, foreclosure is the recourse. The process of foreclosure varies by state and may be judicial or non-judicial depending upon how the state statutory scheme is set up. Real estate investors can think of foreclosure like an eviction of a non-paying tenant only more time consuming and more expensive. Foreclosures may require substantial upfront fees paid to attorneys and/or trustees and can be a stressful process for a note investor to undertake. Many investors shy away from note investments because they do not wish to have to foreclose on a borrower. The risk of foreclosure is directly related to the quality the note investment and the quality of the borrower. Good quality borrowers are as important to note investors as good quality tenants are to real estate investors.

Real Estate Investment Trust Token (REITT)

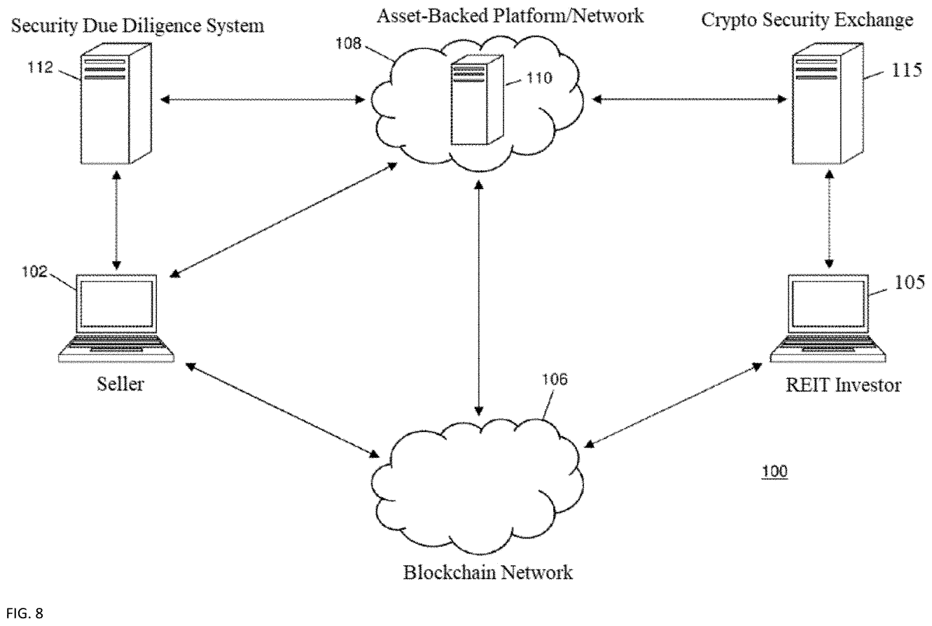

FIG. 8 shows an exemplary embodiment to democratize access to the real estate debt. The system of FIG. 8 is similar to the system of FIG. 1 on the right side, but now the platform/network is the buyer of the tapes of notes and offers the vetted bundles of notes to investors 104 such as REIT investors. The system of FIG. 8 would offer instant liquidity through the BCS that can be traded on security exchanges 115.

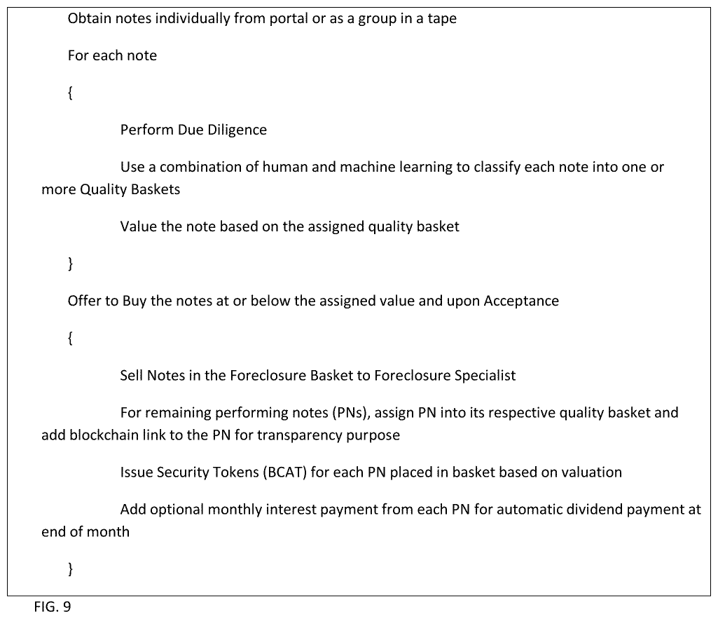

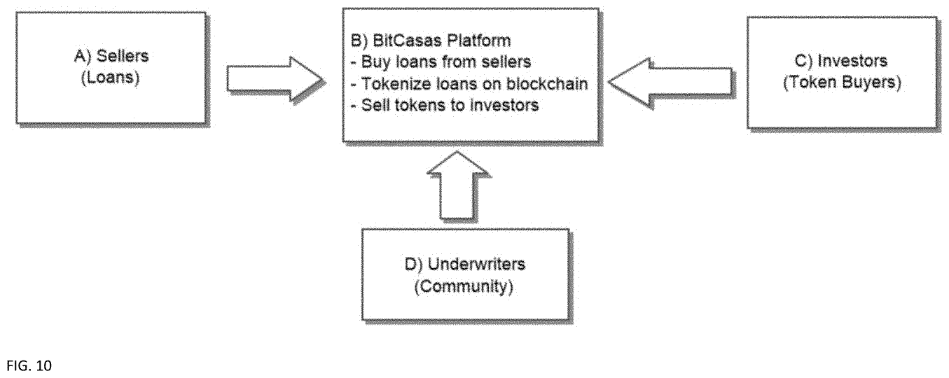

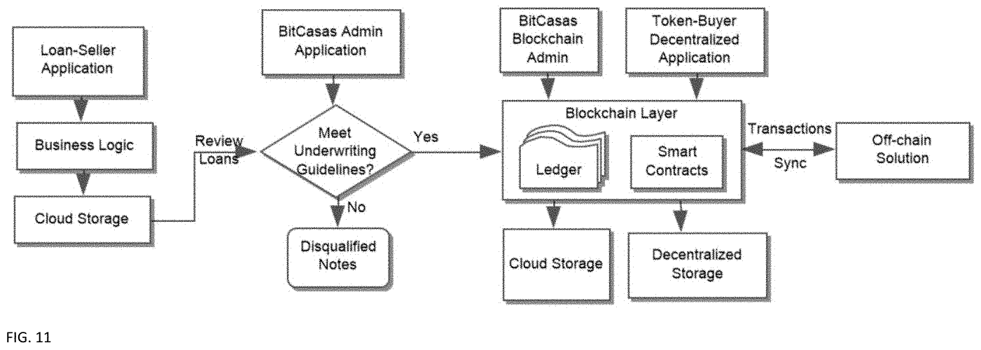

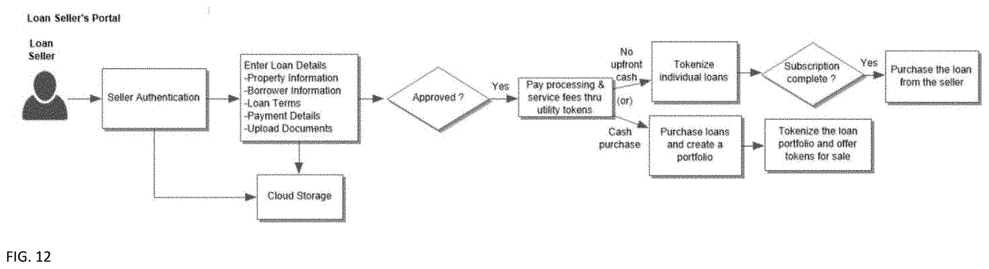

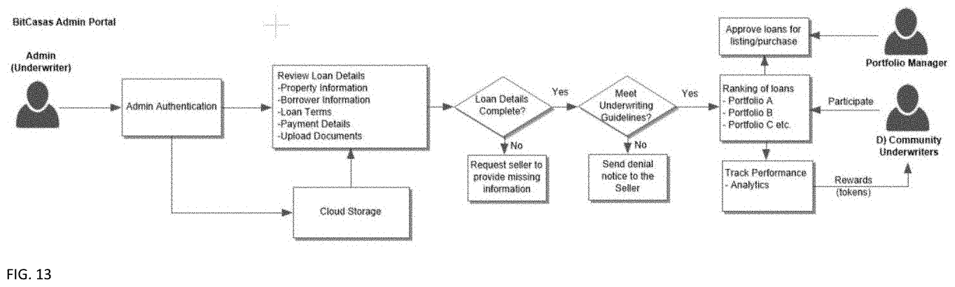

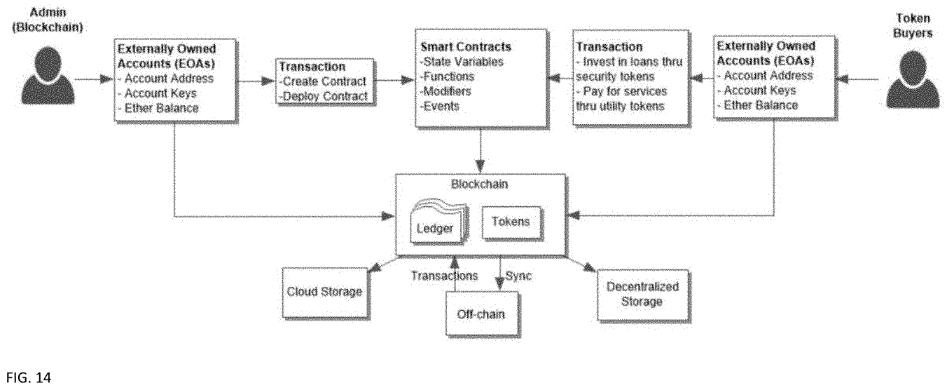

FIG. 9 illustrates an exemplary process to provide blockchain REIT investment system. Pseudo-code is as follows:

Obtain notes individually from portal or as a group in a tape
For each note
{

Perform Due Diligence
Use a combination of human and machine learning to classify

each note into one or more Quality Baskets

Value the note based on the assigned quality basket

}
Offer to Buy the notes at or below the assigned value and upon
Acceptance
{

Sell Notes in the Foreclosure Basket to Foreclosure Specialist
For remaining performing notes (PNs), assign PN into its

respective quality basket and add blockchain link to the PN for
transparency purpose

Issue BCS for each PN placed in basket based on valuation
Add optional monthly interest payment from each PN for

automatic dividend payment at end of month

}

FIGS. 6-10 show exemplary flows in a system to deploy asset-backed tokens. In this embodiment, the assets are real estate assets such as buildings. FIG. 10 shows an exemplary interaction among loan sellers, underwriters, and investors using the platform. In this system, entities owning loans, debts, or mortgages can offer them to the system for buyers using the platform. The platform buys loans and, after ranking and review by community underwriters, tokenizes the loans for investors to invest.

FIG. 11 shows the high-level workflow for the system. First, a loan seller information is processed and stored in cloud storage. The loan seller communications with an administration application layer to check for underwriting guidelines. If the check fails, the note is disqualified. Otherwise, the passing note is provided to a blockchain layer for tokenization. The blockchain includes the ledger and smart contracts. Other inputs to the layer include contract owner information, token buyer. The result stored in cloud storage and/or on decentralized storage such as Swarm or IPFS (interplanetary file system), for example. Other information can be stored off-chain.

For example, when the system adds files to IPFS:

Each file and all of the blocks within it are given a unique fingerprint called a cryptographic hash.

IPFS removes duplications across the network and tracks version history for every file.

Each network node stores only content it is interested in, and some indexing information that helps figure out who is storing what.

When looking up files, the system is asking the network to find nodes storing the content behind a unique hash.

Every file can be found by human-readable names using a decentralized naming system called IPNS.

FIG. 12 shows the seller portal where the seller can enter loan details and upload proof and other validation documents on the cloud storage. Once the loan is approved for purchase, the system pays.

FIG. 13 shows an exemplary admin portal where the admin can review information for completeness and then check for underwriting guidelines. Once approved, the notes can be listed for purchase. All information is stored in cloud storage or distributed decentralized storage as appropriate.

FIG. 14 shows an exemplary contract owner portal where the admin can authenticate and/or login into external owned accounts. The admin can create smart contracts that token buyers can subscribe or agree to. The smart contract is placed onto the blockchain.

Sponsors (i.e., Debtors): A reputation system for sponsors has been developed based on guidelines and historical performance. Also, a smart contract-based liquidation schedule has been implemented to handle risk management.

Investors (i.e., Creditors): A smart contract-based dividend distribution system has been developed for investors, as well as an incentive feature to reward investors who participate in the community-based consensus mechanism that would help rank and choose good deals.

Underwriters: A reputation system for underwriters based on their historical performance has been developed, as well as an immediate fee compensation and long-term incentive bonus mechanisms, which would reward the underwriters over the life of a mortgage loan. Further, some innovative ideas are on the table regarding engaging contract-type community underwriters.

Managers (i.e., Relayers): Similar to underwriters, a reputation system for managers based on the historical performance has been developed. An immediate compensation fee at closing of a deal and long-term portfolio performance/management incentives has also been established. Again, the future platform would consider engaging contract-type community managers to facilitate scaling of the platform.

The platform offers the following features:
A new blockchain-based technology which can create a lower-cost, more efficient investment model for accessing private real estate than anything else available to individuals today.
This online, direct investment model increases transparency, reduces costs, and increases overall risk-adjusted returns.
Investing directly in commercial real estate will become a common practice for individual investors seeking a well-balanced, diversified portfolio.
Making the long-term interests of investors our singular priority allows for a successful and sustainable business.

BitCasas's blockchain based note investment platform takes advantage of the blockchain technology to streamline the investment and servicing process. For example, its smart contracts enable instant transferring of the monthly note payments to investors, replacing expensive sales and management teams with the smart contracts in our blockchain system. The smart contracts provide data driven automated execution, thus maximizing yields available to private market real estate investors. Our smart contract system enables seamless purchase, tracking and reporting of investment returns, including financial updates and tax reporting and enables us to cost-efficiently service investors in comparison to the servicing costs associated with conventional off-line real estate investment firms.

The blockchain platform analyzes the data and helps users in making decisions, and as the amount of data increases, the analysis improves while reducing the fees paid by investors. This system allows for automated payment processing with APIs (application programming interfaces), with personalized dashboards and automated account management and maintenance, including financial updates and tax reporting. Thus, individuals can view and manage their accounts at their own desks, eliminating the usual human interfaces which add extensive costs to the system.

Traders that use BitCasas's platform can offer individuals, smaller investors, to play in the financial real estate market, a dynamic shift from the large financial institutions in power today. By leveraging the power of the Internet and the Blockchain format, smaller investors can get involved at nearly the same price and terms associated with institutional investors.
Steady, predictable return due to the notes interests.
It is a safe and stable investment, as the portfolio is backed by prime real estate, which often has a greater net value than the amount of the lien.
Ability to select specific locations such as West Coast, California, NY, Massachusetts, DC, or the Northwest region, for example.
By eliminating the high fees associated with brokers and investment bankers, upfront costs and fees are reduced by 90 percent compared with publicly traded and non-traded loans.
By attracting multiple investors directly online, raising capital is more efficient and less time consuming than going on the road to attract investors. An average of 16-19 months of road marketing to investors was reported in the Pregin 2015 Fundraising Update. The platform eliminates the cost and time associated with efforts associated with the typical fundraising roadshow.
Accountability and customer service are improved, along with lower cost/fee.
By dividing ownership, the owners of the tokens then have liquidity to buy and sell with ease, at a time which is right for them, not on an annual or quarterly basis like some institutions. Tokens can be easily traded or transferred.

The invention described above is operational with general purpose or special purpose computing system environments or configurations. The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention. Since many embodiments of the present invention can be made without departing from the spirit and intended scope of the invention, the invention resides in the claims hereinafter appended.

What is claimed is:

1. A method to tokenize an asset, comprising:
documenting a value for the asset by a promoter of the asset,
generating a plurality of cryptocurrency coins/tokens corresponding to the value of the asset;
embedding in the cryptocurrency coins/tokens a smart contract one or more investment terms including asset description, payment and timing; obtaining subscriptions and payments for the asset from a crowd;
holding subscription payments from the crowd in escrow until a predefined condition is met; and
releasing the coins/tokens to the promoter and recording ownership interest from the crowd.

2. The method of claim 1, wherein the asset is real estate notes, comprising tokenizing the real estate notes.

3. The method of claim 1, comprising providing a trustee to hold one or more trusts.

4. The method of claim 1, comprising servicing the notes with a service company.

5. The method of claim 1, comprising offering the coins/tokens as a security in an offering.

6. The method of claim 1, comprising offering the coins/tokens as a non-security in an offering.

7. The method of claim 1, comprising trading the coins/tokens in a security token exchange.

8. The method of claim 1, comprising minting the coins/tokens in a tokenization process.

9. The method of claim 1, comprising providing the coins/tokens to a custodian to release upon payment from investors

10. The method of claim 1, comprising performing anti-money laundering (AML) and know your customer (KYC).

11. The method of claim 1, comprising minting stablecoins/tokens.

12. The method of claim 1, comprising storing the coins/tokens in a wallet with a wallet address

13. The method of claim 1, comprising paying rent income stream to the trust and minting additional coins/tokens based on the rent income stream.

14. The method of claim 13, comprising distributing additional coins/tokens to investors.

15. The method of claim 13, comprising distribution of rent/interest income to investors using stablecoins/tokens.

16. A system to handle real estate notes, comprising:
a blockchain;
a processor coupled to the blockchain;
code executable by the processor to:
document a value for the asset by a promoter of the asset,
generate a plurality of cryptocurrency coins/tokens corresponding to the value of the asset;
embed in the cryptocurrency coins/tokens a smart contract one or more investment terms including asset description, payment and timing; obtaining subscriptions and payments for the asset from a crowd;
hold subscription payments from the crowd in escrow until a predefined condition is met; and
release the coins/tokens to the promoter and recording ownership interest from the crowd.

17. The system of claim 16, wherein the asset is real estate notes, comprising tokenizing the real estate notes.

18. The system of claim 16, comprising code to provide a trustee to hole one or more trusts.

19. The system of claim 16, comprising code to service the notes with a service company.

20. The system of claim 16, comprising code to pay rent income stream to the trust and minting additional coins/tokens based on the rent income stream.

21. The system of claim 19, comprising code to distribute additional coins/tokens to investors.
